(19) United States
(12) Patent Application Publication
(10) Pub. No.: US 2008/0288671 A1
(43) Pub. Date: Nov. 20, 2008

(54) Virtualization by multipath management software for a plurality of storage volumes

(75) Inventor: Haruki Masuda, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/010,493

(22) Filed: Jan. 25, 2008

(30) Foreign Application Priority Data
May 16, 2007 (JP) 2007-130385

(51) Int. Cl. G06F 9/46

(52) U.S. Cl. 710/38

(57) ABSTRACT

A path management method for a computer system which includes first and second storage controllers and a host computer, the first controller providing a first volume to the host computer, the second controller providing a second volume to the host computer, the host computer including one or more task application units and a path management unit, the path management method including: setting, by the path management unit, a plurality of first paths and a plurality of second paths; providing, by the path management unit, the first and second volumes as third volume to the task application unit; and transmitting, by the path management unit, through the first path write request for writing data in the third volume which is issued from the task application unit.

### CLAIM OF PRIORITY

The present application claims priority from Japanese patent application P2007-130385 filed on May 16, 2007, the content of which is hereby incorporated by reference into this application.

### BACKGROUND

This invention relates to a path management method for a computer system which includes first and second storage controllers, and a host computer, and more particularly, to a technology of selecting a path used for transmitting an I/O request.

A multipath computer system used under a storage area network (SAN) environment has been known. The multipath computer system includes a storage system and a host computer. The storage system and the host computer are interconnected by a SAN which includes a fibre channel switch.

In the multipath computer system, logical units (LU's) provided by the storage system and the host computer are interconnected through a plurality of logical paths. The logical path is a path made redundant according to a combination of physical paths in a communication path between the host computer and the storage system. The physical path is an I/O request path for interconnecting the host computer and the storage system. For example, the I/O request path is a SCSI cable or a fibre cable.

JP 2005-10956 A discloses an access method for the multipath computer system. According to the technology of JP 2005-10956 A, logical paths are sequentially selected by a round robin system. Then, the host computer uses the selected logical paths to transmit an I/O request to the LU of the storage system.

### SUMMARY

According to the technology disclosed in JP 2005-10956 A, one of the LU's is provided as an integrated device to a task application. Thus, when the logical paths coupled to one LU are all closed, an operation of the task application cannot be continued. In this case, a manager has to manually restore the operation from a failure. As a result, it is impossible to quickly restore the computer system from a failure.

This invention has been developed with the aforementioned problem in mind, and it is an object of the invention to provide a computer system which can be quickly restored from a failure.

According to an exemplary embodiment of this invention, there is provided a path management method for a computer system comprising: a first storage controller; a second storage controller; and a host computer coupled to the first and second storage controllers, the first storage controller providing a first volume to the host computer, the second controller providing a second volume making a pair with the first volume to the host computer, the host computer including: at least one task application unit for issuing a write request and a read request; and a path management unit for managing an access route to each of the volumes, the path management method comprising: setting, by the path management unit, a plurality of first paths serving as access routes from the host computer to the first volume, and a plurality of second paths serving as access routes from the host computer to the second volume; providing, by the path management unit, the first and second volumes as third volume to the task application unit; and transmitting, by the path management unit, through the first path the write request for writing data in the third volume which is issued from the task application unit.

According to the representative embodiment of this invention, the computer system can be quickly restored from a failure.

### BRIEF DESCRIPTION OF THE DRAWINGS

The present invention can be appreciated by the description which follows in conjunction with the following figures, wherein:

FIG. 1 is a block diagram showing a configuration of a computer system according to a first embodiment of this invention;

FIG. 2 is a block diagram showing a configuration of a host computer installed in the computer system according to the first embodiment of this invention;

FIG. 3 is a block diagram showing a configuration of a management server installed in the computer system according to the first embodiment of this invention;

FIG. 4 is an explanatory diagram of a integrated device of the computer system according to the first embodiment of this invention;

FIG. 5 is a diagram showing a configuration of a integrated device ID table stored in the host computer according to the first embodiment of this invention;

FIG. 6 is a diagram showing a configuration of a path management table stored in the host computer according to the first embodiment of this invention;

FIG. 7 is a diagram showing a configuration of a LU management table stored in the management server according to the first embodiment of this invention;

FIG. 8 is a diagram showing a configuration of a copy pair management table stored in the management server according to the first embodiment of this invention;

FIG. 9 is an explanatory diagram of an integration device creation process of the management server according to the first embodiment of this invention;

FIG. 10 is a flowchart of the integrated device creation process of the management server according to the first embodiment of this invention;

FIG. 11 is a diagram showing a configuration of the copy pair creation notification transmitted from the management server to the host computer according to the first embodiment of this invention;

FIG. 12 is a flowchart showing a process when the copy pair creation notification is received by the host computer according to the first embodiment of this invention;

FIG. 13 is an explanatory diagram of a copy pair main/sub switching process of the management server according to the first embodiment of this invention;

FIG. 14 is a flowchart of the copy pair main/sub switching process of the management server according to the first embodiment of this invention;

FIG. 15 is a diagram showing a configuration of a copy pair changing notification transmitted from the management server to the host computer according to the first embodiment of this invention;

FIG. 16 is a flowchart of a process when the host computer receives the copy pair changing notification according to the first embodiment of this invention;

FIG. 17 is an explanatory diagram of an integrated device releasing process of the management server according to the first embodiment of this invention;

FIG. 18 is a flowchart of the integrated device releasing process of the management server according to the first embodiment of this invention;

FIG. 19 is a diagram showing a configuration of a copy pair release notification transmitted from the management server to the host computer according to the first embodiment of this invention;

FIG. 20 is a flowchart of a process when the host computer receives the copy pair release notification according to the first embodiment of this invention;

FIG. 21 is an explanatory diagram of a copy holding process of the management server according to the first embodiment of this invention;

FIG. 22 is a flowchart of the copy holding process of the management server according to the first embodiment of this invention;

FIG. 23 is a diagram showing a configuration of a copy holding request transmitted from the management server to the host computer according to the first embodiment of this invention;

FIG. 24 is a flowchart of a process when the host computer receives the copy holding request according to the first embodiment of this invention;

FIG. 25 is an explanatory diagram of a storage system replacing process of the computer system according to the first embodiment of this invention;

FIG. 26 is an explanatory diagram of the storage system replacing process of the computer system according to the first embodiment of this invention;

FIG. 27 is an explanatory diagram of the storage system replacing process of the computer system according to the first embodiment of this invention;

FIG. 28 is an explanatory diagram of the storage system replacing process of the computer system according to the first embodiment of this invention;

FIG. 29 is an explanatory diagram of the storage system replacing process of the computer system according to the first embodiment of this invention;

FIG. 30 is an explanatory diagram of the computer system at a normal time according to the first embodiment of this invention;

FIG. 31 is a diagram of the path management table stored in the host computer at normal times according to the first embodiment of this invention;

FIG. 32 is an explanatory diagram of a process when a device link manager of the host computer detects a failure according to the first embodiment of this invention;

FIG. 33 is a flowchart of the process when the device link manager of the host computer detects a failure according to the first embodiment of this invention;

FIG. 34 is a flowchart of a process when the management server receives the I/O failure notification according to the first embodiment of this invention;

FIG. 35 is an explanatory diagram of a process executed by the host computer when a path failure occurs according to the first embodiment of this invention;

FIG. 36 is a flowchart of the process executed by the host computer when the path failure occurs according to the first embodiment of this invention;

FIG. 37 is a diagram showing a configuration of the path management table stored in the host computer after the path failure occurs according to the first embodiment of this invention;

FIG. 38 is an explanatory diagram of a process executed by the host computer when an LU failure occurs according to the first embodiment of this invention;

FIG. 39 is a flowchart of the process executed by the host computer when the LU failure occurs according to the first embodiment of this invention;

FIG. 40 is a diagram showing a configuration of the path management table stored in the host computer after the LU failure occurs according to the first embodiment of this invention;

FIG. 41 is an explanatory diagram of a process executed by the host computer when a copy path failure occurs according to the first embodiment of this invention;

FIG. 42 is a flowchart of the process executed by the host computer when the copy path failure occurs according to the first embodiment of this invention;

FIG. 43 is a diagram showing a configuration of the path management table stored in the host computer after the LU failure occurs according to the first embodiment of this invention;

FIG. 44 is an explanatory diagram of an integrated device of the computer system according to the second embodiment of this invention; and

FIG. 45 is a diagram showing a configuration of a path management table stored in a host computer according to the second embodiment of this invention.

### DETAILED DESCRIPTION OF THE PREFERRED EMBODIMENTS

The preferred embodiments of this invention will be described below referring to the drawings.

### First Embodiment

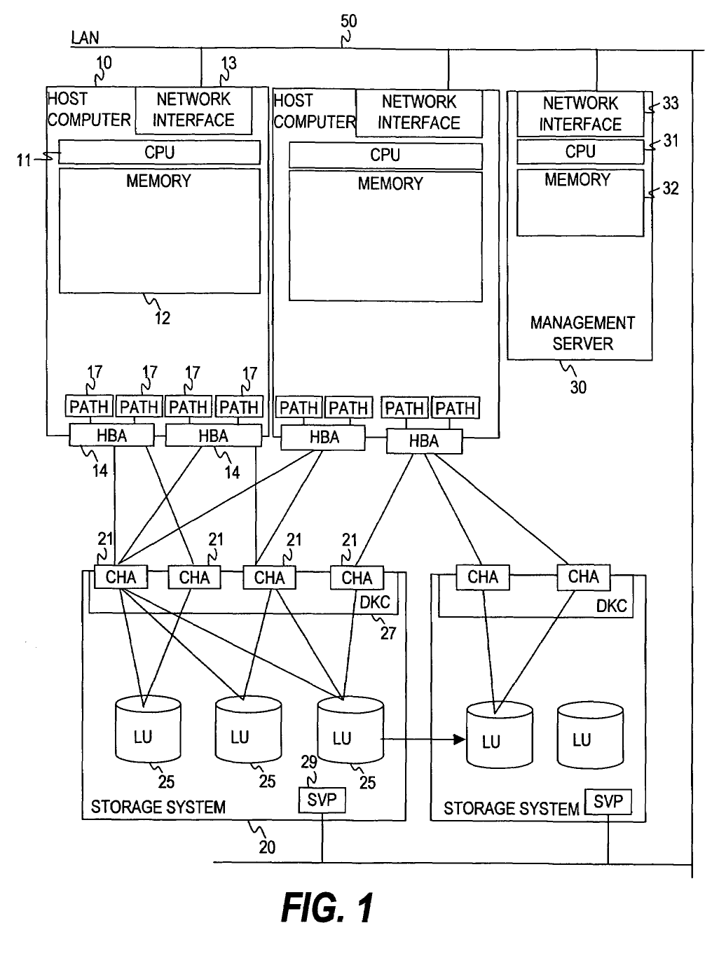

FIG. 1 is a block diagram showing a configuration of a computer system according to a first embodiment of this invention.

The computer system includes a host computer 10, a storage system 20, and a management server 30.

The host computer 10 and the storage system 20 are interconnected through a SAN. The SAN includes one or more fibre channel switches. The fibre channel switch controls communication between the host computer 10 and the storage system 20.

According to the embodiment, logical units (LU's) 25 provided by the storage system 20 and the host computer 10 are interconnected through a plurality of logical paths (hereinafter, referred to simply as paths) 17. The path 17 is an access route from the host computer 10 to the LU 25. Specifically, the path 17 is a logical path made redundant according to a combination of physical paths in a communication route between the host computer 10 and the storage system 20.

The host computer 10, the management server 30, and the storage system 20 are interconnected via a LAN 50.

Two host computers 10 are shown, but the computer system may include any number of host computers 10. Similarly, two storage systems 20 are shown, but the computer system may include any number of storage systems 20.

The storage system 20 includes a disk controller (DKC) 27, a physical disk, and a service processor (SVP) 29. The storage system 20 may include a flash memory in place of the physical disk.

The disk controller 27 reads/writes data in the physical disk. The disk controller 27 provides storage areas of the physical disk as one or more logical units (LU's) 25 to the host computer 10.

The disk controller 27 includes one or more channel adaptors (CHA) 21. The CHA 21 controls data transfer with the host computer 10. The CHA 21 includes a CPU, a memory, and a CHA port. The CHA port is an interface connected to the SAN. The CPU executes programs stored in the memory to carry out various processes. The memory stores programs executed by the CPU and information necessary for the CPU.

The SVP 29 receives an instruction from the management server 30, and carries out a process according to the received instruction.

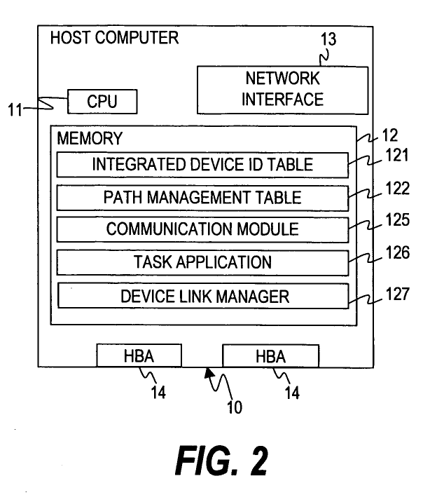

The host computer 10 transmits an I/O request to the storage system 20. The I/O request contains a write request and a read request. Accordingly, the host computer 10 requests the storage system 20 to read/write data from/in the LU 25. The host computer 10 will be described in detail referring to FIG. 2.

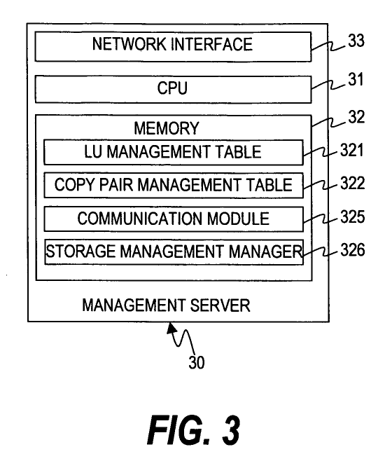

The management server 30 manages a process of the computer system overall. The management server 30 will be described in detail referring to FIG. 3.

FIG. 2 is a block diagram showing a configuration of the host computer 10 installed in the computer system according to the first embodiment of this invention.

The host computer 10 includes a CPU 11, a memory 12, a network interface 13, and a host bus adaptor (HBA) 14. In the diagram, one host computer 10 includes two HBA's 14. However, any number of HBA's 14 may be included therein.

The network interface 13 is an interface connected to the LAN 50. The HBA 14 is an interface connected to the storage system 20 via the SAN.

The CPU 11 executes programs stored in the memory 12 to carry out various processes.

The memory 12 stores programs executed by the CPU 11, information necessary for the CPU 11, or the like. Specifically, the memory 12 stores an integrated device ID table 121, a path management table 122, a communication module 125, a task application 126, and a device link manager 127. The memory 12 may store pluralities of integrated device ID tables 121 and task applications 126. One integrated device ID table 121 corresponds to one task application 126.

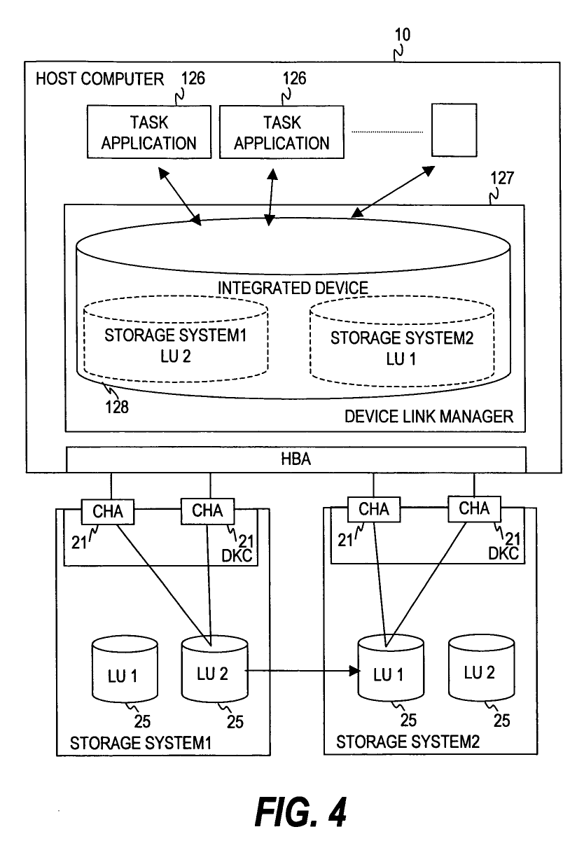

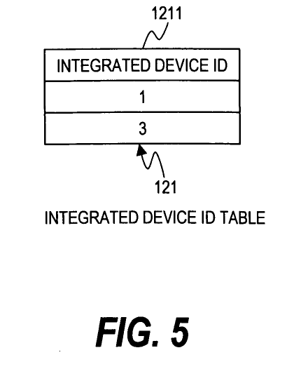

The integrated device ID table 121 indicates correspondence between the task application 126 and an integrated device 128 which can be used by the task application 126. The integrated device 128 will be described in detail referring to FIG. 4. The integrated device ID table 121 will be described in detail referring to FIG. 5.

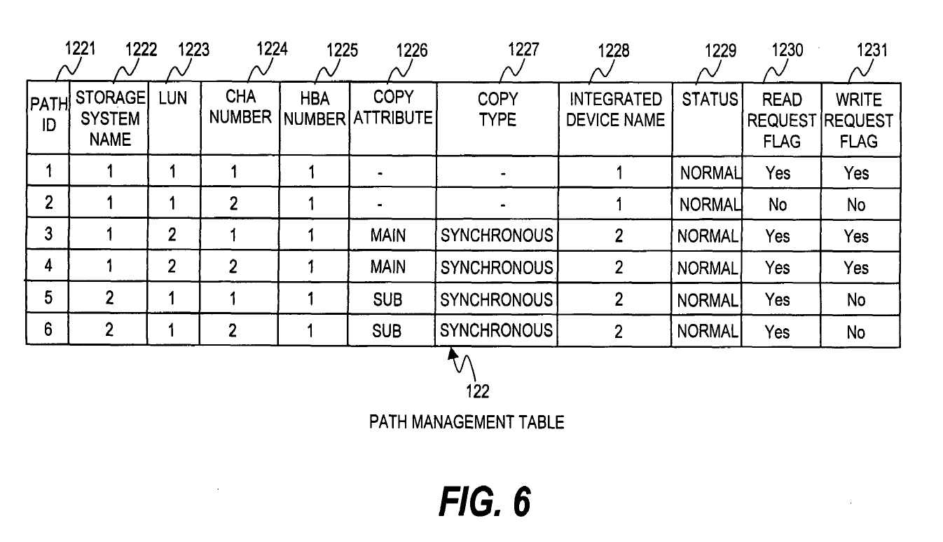

The path management table 122 indicates information regarding the path 17 connected to the host computer 10. The path management table 122 will be described in detail referring to FIG. 6.

The communication module 125 is a program for communicating with the management server 30 via the LAN 50. The task application 126 is a program for executing a specific process. The task application 126 issues an I/O request to the integrated device 128.

The device link manager 127 is a program for managing the path 17. For example, the device link manager 127 makes redundant the physical path for interconnecting the host computer 10 and the storage system 20 to provide a path 17.

The device link manager 127 includes a load balance function. In other words, the device link manager 127 transmits a plurality of I/O requests from different paths 17 to distribute loads of the paths 17.

For example, upon transmission of a predetermined number of I/O requests by using one path 17, the device link manager 127 selects a subsequent path 17. Then, the device link manager 127 transmits the I/O requests by using the selected subsequent path 17. The device link manager 127 may transmit I/O requests to continuous blocks by using the same path 17. The device link manager 127 selects the path 17 used for transmitting the I/O requests by referring to the path management table 122.

The device link manager 127 includes a path alternating function. Specifically, upon detection of a failure in the path 17, the device link manager 127 closes the path 17 whose failure has been detected. Accordingly, the device link manager 127 does not transmit any I/O request by using the failure-detected path 17. Instead, the device link manager 127 transmits I/O requests by using an unclosed path 17.

The device link manager 127 can detect a failure of the path 17 by executing a failure detection process (path health check) of the path 17.

Specifically, the device link manager 127 transmits INQUIRY of a SCSI command as a failure detection signal (continuity check signal) to the storage system 20 by using a path 17 whose status is to be checked. Then, the device link manager 127 judges a status of the path 17 based on whether the failure detection signal has been normally transmitted. Specifically, if the failure detection signal has been normally transmitted, the device link manager 127 judges that the path 17 is normal. On the other hand, if the failure detection signal is not normally transmitted, the device link manager 17 judges that a failure has occurred in the path 17.

The device link manager 127 provides the integrated device 128 to the task application 126. The integrated device 128 will be described in detail referring to FIG. 4.

FIG. 3 is a block diagram showing a configuration of the management server 30 installed in the computer system according to the first embodiment of this invention.

The management server 30 includes a CPU 31, a memory 32, and a network interface 33. The network interface 33 is an interface connected to the host computer 10 and the storage system 20 via the LAN 50. The CPU 31 executes programs stored in the memory 32 to carry out various processes.

The memory 32 stores programs executed by the CPU 31 and information necessary for the CPU 31. Specifically, the memory 32 stores an LU management table 321, a copy pair management table 322, a communication module 325, and a storage management manager 326.

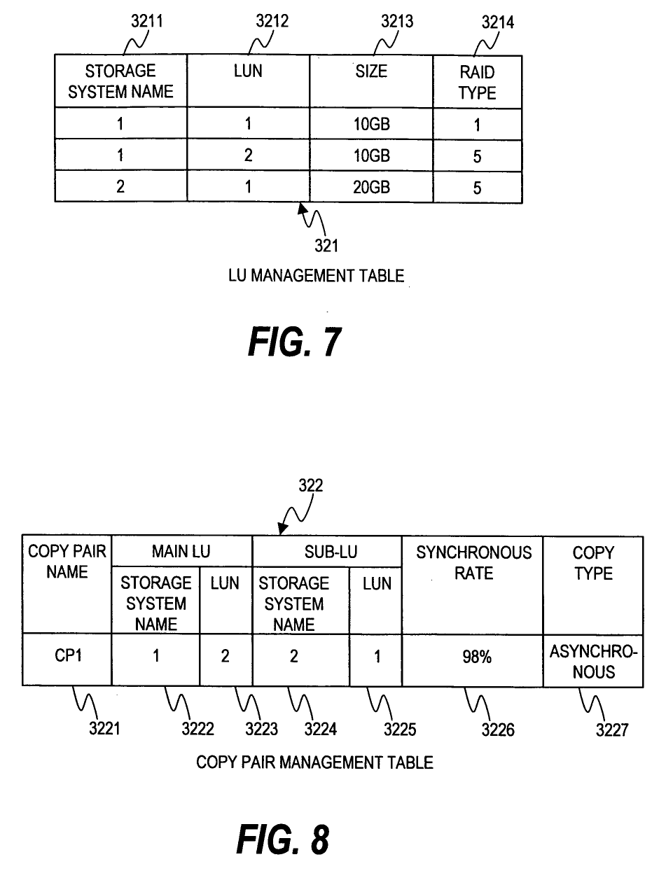

The LU management table 321 indicates information regarding the LU 25 provided by the storage system 20. The LU management table 321 will be described in detail referring to FIG. 7.

The copy pair management table 322 manages a copy pair which mainly includes a main LU 25 and a sub-LU 25. The main LU 25 is an LU 25 where data is written based on a write request from the host computer 10. Accordingly, the main LU 25 is a source. The sub-LU 25 is an LU 25 which constructs the copy pair with the main LU 25. Accordingly, the sub-LU 25 is a destination of data written in the main LU 25.

In the embodiment, the term “copy” includes synchronous copy and asynchronous copy. The storage system 20 that provides the main LU 25 and the storage system 20 that provides the sub-LU 25 may be the same or different.

The communication module 325 is a program for communicating with the host computer 10 and the storage system 20 via the LAN 50.

The storage management manager 326 is a program for managing the storage system 20.

FIG. 4 is an explanatory diagram of the integrated device 128 of the computer system according to the first embodiment of this invention.

The device link manager 127 of the host computer 10 provides two LU's 25 making a copy pair as one integrated device 128 to one or more task applications 126. In other words, the device link manager 127 of the host computer 10 provides a main LU 25 and a sub-LU 25 making a copy pair as one integrated device 128 to one or more task applications 126.

Accordingly, the task application 126 issues an I/O request to the provided integrated device 128. In other words, the task application 126 uses the provided integrated device 128 to access the LU 25 provided by the storage system 20.

In this case, the device link manager 127 of the host computer 10 properly changes a path 17 used for transmitting the I/O request issued from the task application 126. Thus, the device link manager 127 of the host computer 10 realizes a load balance function and a path alternating function without being sensed by the task application 126. In other words, the task application 126 can access the LU 25 using a proper path 17 only by issuing an I/O request to the integrated device 128.

For example, the device link manager 127 of the host computer 10 transmits the I/O request issued from the task application 126 to the storage system 20 only by using the path 17 connected to the main LU 25. When data of the main LU 25 has synchronously been copied to the sub-LU 25, the device link manager 127 of the host computer 10 may transmit a read request issued from the task application 126 to the storage system 20 by using not only the path 17 connected to the main LU 25 but also the path 17 connected to the sub-LU 25.

FIG. 5 is a diagram showing a configuration of the integrated device ID table 121 stored in the host computer 10 according to the first embodiment of this invention.

The integrated device ID table 121 corresponds to one of the task applications 126 stored in the host computer 10. Thus, the host computer 10 stores the same number of integrated device ID tables 121 as that of task applications 126.

The integrated device ID table 121 includes an integrated device ID 1211. The integrated device ID 1211 is a unique identifier of an integrated device 128 which can be used by the task application 126 corresponding to the integrated device ID table 121.

FIG. 6 is a diagram showing a configuration of the path management table 122 stored in the host computer 10 according to the first embodiment of this invention.

The path management table 122 includes a path ID 1221, a storage system name 1222, an LUN 1223, a CHA number 1224, an HBA number 1225, a copy attribute 1226, a copy type 1227, an integrated device name 1228, a status 1229, a read request flag 1230, and a write request flag 1231.

The path ID 1221 is a unique identifier of the path 17 connected to the host computer 10. The storage system name 1222 is a unique identifier of the storage system 20 connected to the path 17 identified by a path ID 1221 of the record. The LUN 1223 is a unique identifier of the LUN 25 connected to the path 17 identified by the path ID 1221 of the record. The host computer 10 identifies the LU 25 by using the storage system name 1222 and the LUN 1223.

The CHA number 1224 is a unique identifier of a CHA 21 through which the path 17 identified by the path ID 1221 of the record passes. The host computer 10 identifies the CHA 21 by using the storage system name 1222 and the CHA number 1224.

The HBA number 1225 is a unique identifier of an HBA 14 through which the path 17 identified by the path ID 1221 of the record passes.

The copy attribute 1226 indicates which of the main LU 25 and the sub-LU 25 the LU 25 connected to the path 17 identified by the path ID 1221 of the record is. In other words, the copy attribute 1226 indicates which of the main LU 25 and the sub-LU 25 the LU 25 identified by the storage system name 1222 and the LUN 1223 of the record is. When the LU 25 is neither the main LU 25 nor the sun-LU 25, no value is stored in the copy attribute 1226. In other words, when the LU 25 does not make a pair, no value is stored in the copy attribute 1226.

The copy type 1227 indicates which of a synchronous copy and an asynchronous copy is applied to the copy pair including the LU 25 connected to the path 17 identified by the path ID 1221 of the record. In other words, the copy type 1227 indicates whether the LU 25 connected to the path 17 identified by the path ID 1221 of the record is synchronous with the LU 25 making a copy pair with the LU 25.

The integrated device name 1228 is a unique identifier of the integrated device 128 corresponding to the path 17 identified by the path ID 1221 of the record. When the task application 126 issues an I/O request to the integrated device 128, the device link manager 127 transmits the I/O request to the storage system 20 by using the path 17 corresponding to the integrated device 128.

The status 1229 indicates whether the path 17 identified by the path ID 1221 of the record is normal, abnormal, or copy-path abnormal. If the status 1229 indicates an abnormality, a failure has occurred in at least one of the path 17 identified by the path ID 1221 of the record and the LU 25 identified by the LUN 1223 of the record. If the status 1229 indicates a copy-path abnormality, a failure has occurred in a copy path connected to the LU 25 identified by the LUN 1223 of the record. The copy path is a path for interconnecting two LU's 25 making a copy pair. A logical path or a physical dedicated line (physical path) may be used for the copy path as long as the path interconnects the two LU's 25 making the copy pair.

The read request flag 1230 indicates whether a read request can be transmitted by using the path 17 identified by the path ID 1221 of the record. The write request flag 1231 indicates whether a write request can be transmitted by using the path 17 identified by the path ID 1221 of the record.

The device link manager 127 of the host computer 10 selects a path 17 used for transmitting the I/O request issued to the integrated device 128 based on the path management table 122.

First, a case where the I/O request is a write request will be described. The device link manager 127 of the host computer 10 selects all records where an identifier of the integrated device 128 as an issuance destination of the write request matches the integrated device name 1228 of the path management table 122 from the path management table 122.

Then, the device link manager 127 of the host computer 10 judges whether a status 1229 of the selected record indicates a copy-path abnormality.

If the status 1229 indicates a normal or abnormal status, the device link manager 127 of the host computer 10 selects all records where the write request flag 1231 of the path management table 122 indicates transmission permission of the write request from the selected records.

The device link manager 127 of the host computer 10 extracts path ID's 1221 from all the selected records. The device link manager 127 of the host computer 10 then selects one of all the paths 17 identified by the extracted path ID's 1221 by a round robin system. The device link manager 127 of the host computer 10 transmits the write request by using the selected path 17.

The record where the write request flag 1231 of the path management table 122 indicates transmission permission of the write request corresponds to the path 17 connected to the main LU 25. Accordingly, the device link manager 127 of the host computer 10 transmits the write request issued to the integrated device 128 only by using the path 17 connected to the main LU 25.

On the other hand, if the status 1229 indicates a copy-path abnormality, the device link manager 127 of the host computer 10 extracts LUN's 1223 from all the selected records. Then, the device link manager 127 of the host computer 10 sequentially selects different values from all the extracted LUN's 1223. In other words, the device link manager 127 of the host computer 10 sequentially selects all the LU's 25 provided as integrated devices 128 of issuance destinations of the write request. Then, the device link manager 127 of the host computer 10 selects all records where selected values (identifiers of the LU's 25) match the LUN's 1223 of the path management table 123 from the selected records. The device link manager 127 of the host computer 10 selects all records where the write request flag 1231 of the path management table 122 indicates transmission permission of the write request from the selected records.

Next, the device link manager 127 of the host computer 10 extracts path ID's 1221 from all the selected records. Then, the device link manager 127 of the host computer 10 selects one of all the paths 17 identified by the extracted path ID's 1221 by the round robin system. The device link manager 127 of the host computer 10 transmits a write request by using the selected path 17. In other words, the device link manager 127 of the host computer 10 transmits a write request for each LU 25 provided as the integrated device 128 of an issuance destination of the write request by using the path 17 connected to each LU 25.

Thus, when the status 1229 indicates a copy-path abnormality, the device link manager 127 of the host computer 10 transmits write requests to all the LU's 25 provided as integrated devices 128 of issuance destinations of the write requests. As a result, consistency of data of all the LU's 25 provided as the same integrated device 128 is maintained.

Next, a case where the I/O request is a read request will be described. The device link manager 127 of the host computer 10 selects all records where an identifier of the integrated device 128 of the issuance destination of a read request matches an integrated device name 1228 of the path management table 122 from the path management table 122. Then, the device link manager 127 of the host computer 10 selects all records where the read request flag 1230 of the path management table 122 indicates transmission permission of the read request from the selected records. The device link manager 127 of the host computer 10 extracts path ID's 1221 from all the selected records. The device link manager 127 of the host computer 10 selects one of all the paths 17 identified by the extracted path ID's 1221 by the round robin system. The device link manager 127 of the host computer 10 transmits the read request by using the selected path 17.

If a synchronous copy is applied to the copy pair, a record where the read request flag 1230 of the path management table 122 indicates transmission permission of the read request corresponds to one of the path 17 connected to the main LU 25 and the path 17 connected to the sub-LU 25. Accordingly, the device link manager 127 of the host computer 10 transmits the read request issued to the integrated device 128 by using both of the path 17 connected to the main LU 25 and the path 17 connected to the sub-LU 25.

On the other hand, if an asynchronous copy is applied to the copy pair, a record where the read request flag 1230 of the path management table 122 indicates transmission permission of the read request corresponds to only the path 17 connected to the main LU 25. Thus, the device link manager 127 of the host computer 10 transmits the read request issued to the integrated device 128 by using only the path 17 connected to the main Lu 25.

FIG. 7 is a diagram showing a configuration of the LU management table 321 stored in the management server 30 according to the first embodiment of this invention.

The LU management table 321 includes a storage system name 3211, an LUN 3212, a size 3213, and a RAID type 3214.

The storage system name 3211 is a unique identifier of the storage system 20 managed by the management server 30. The LUN 3212 is a unique identifier of the LU 25 provided by the storage system 20 identified by the storage system name 3211 of the record. The management server 30 identifies the LU 25 by using the storage system name 3211 and the LUN 3212.

The size 3213 is a maximum data amount to be stored in the LU 25 identified by the storage system name 3211 and the LUN 3212 of the record. The RAID type 3214 is a type of RAID applied to the LU 25 identified by the storage system name 3211 and the LUN 3212 of the record.

FIG. 8 is a diagram showing a configuration of the copy pair management table 322 stored in the management server 30 according to the first embodiment of this invention.

The copy pair management table 322 includes a copy pair name 3221, main LU information, sub-LU information, a synchronous rate 3226, and a copy type 3227.

The copy pair name 3221 is a unique identifier of a copy pair formed in the computer system.

The main LU information contains a storage system name 3222 and an LUN 3223. The storage system name 3222 is a unique identifier of the storage system 20 which provides the main LU 25 making a copy pair identified by the copy pair name 3221 of the record. The LUN 3223 is a unique identifier of the main LU 25 making the copy pair identified by the copy pair name 3221 of the record.

The sub-LU information contains a storage system name 3224 and an LUN 3225. The storage system name 3224 is a unique identifier of the storage system 20 which provides the sub-LU 25 making a copy pair identified by the copy pair name 3221 of the record. The LUN 3225 is a unique identifier of the sub-LU 25 making the pair identified by the copy pair name 3221 of the record.

The synchronous rate 3226 indicates a rate of matching of data between the main LU 25 and the sub-LU 25 making the copy pair identified by the copy pair name 3221 of the record. In other words, the synchronous rate 3226 indicates a rate of matching of data between the main LU 25 identified by the storage system name 3222 and the LUN 3223 of the record and the sub-LU 25 identified by the storage system name 3224 and the LUN 3225 of the record. Accordingly, when the synchronous copy is applied to the copy pair, the synchronous rate 3226 is “100%”.

The copy type 3227 indicates which of a synchronous copy and an asynchronous copy is applied to the copy pair identified by the copy pair name 3221 of the record.

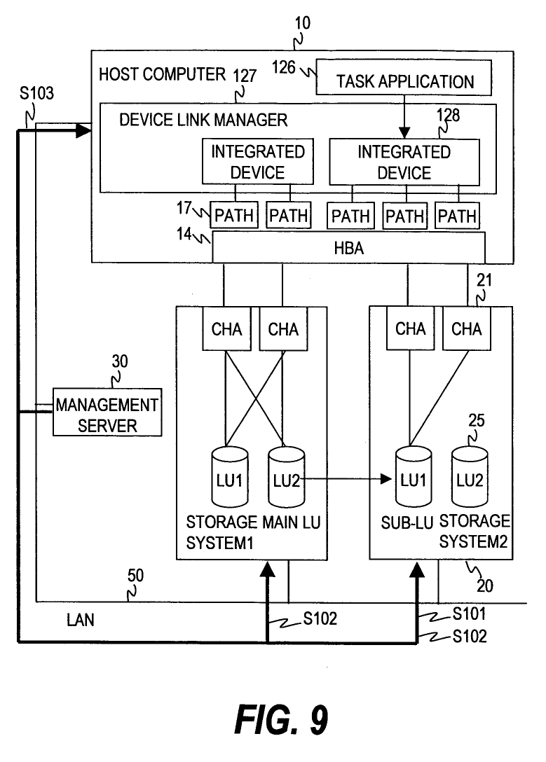

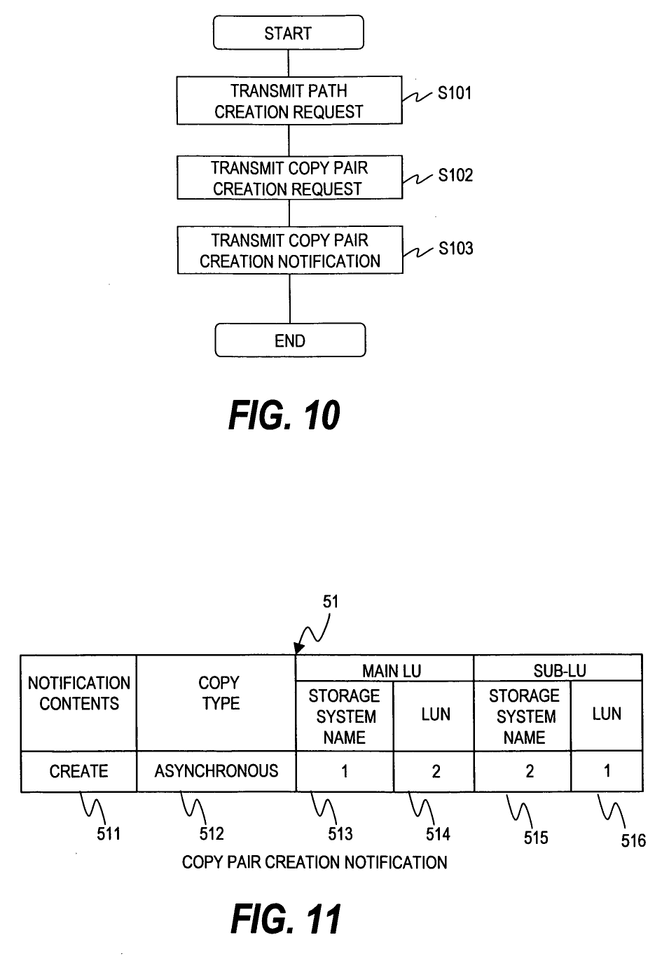

FIG. 9 is an explanatory diagram of an integration device creation process of the management server 30 according to the first embodiment of this invention. FIG. 10 is a flowchart of the integrated device creation process of the management server 30 according to the first embodiment of this invention.

When requested to execute an integrated device creation process by a user (manager) of the management server 30 or the device link manager 127 of the host computer 10, the management server 30 executes the integrated device creation process.

First, the management server 30 transmits a creation request of a path 17 for connecting the LU 25 provided as an integrated device 128 to be created with the host computer 10 to the storage system 20 which provides the LU 25 (S101).

The storage system 20 receives the creation request of the path 17. Then, the storage system 20 creates the requested path 17. Specifically, the storage system 20 creates the path 17 for connecting the LU 25 provided as the integrated device 128 with the host computer 10.

In this case, the device link manager 127 of the host computer 10 updates the path management table 122.

Specifically, the device link manager 127 of the host computer 10 creates a new record in the path management table 122. Then, the device link manager 127 of the host computer 10 stores a value not overlapping with the path ID's 1221 of all the records included in the path management table 122 in a path ID 1221 of the new record. The device link manager 127 of the host computer 10 stores an identifier of the storage system 20 connected to the created path 17 in a storage system name 1222 of the new record. The device link manager 127 of the host computer 10 stores an identifier of the LU 25 connected to the created path 17 in an LUN 1223 of the new record. The device link manager 127 of the host computer 10 stores an identifier of a CHA 21 through which the created path 17 passes in a CHA number 1224 of the new record. The device link manager 127 of the host computer 10 stores an identifier of an HBA 14 through which the created path 17 passes in an HBA number 1225 of the new record. The device link manager 127 of the host computer 10 stores information indicating that the path 17 is normal in a status 1229 of the new record.

The management server 30 transmits a copy pair creation request to the storage system 20 which provides an LU 25 corresponding to the integrated device 128 to be created (S102). Specifically, the management server 30 transmits the copy pair creation request to the storage system 20 which provides the main LU 25 and the storage system 20 which provides the sub-LU 25.

The storage system 20 receives the copy pair creation request. Then, the storage system 20 creates a requested copy pair. Specifically, the storage system 20 copies data written in the main LU 25 to the sub-LU 25.

Then, the management server 30 updates the copy pair management table 322.

Specifically, the management server 30 creates a new record in the copy pair management table 322. The management server 30 stores a value not overlapping with copy pair names 3221 of all the records included in the copy pair management table 322 in a copy pair name 3221 of the new record.

The management server 30 stores an identifier of the storage system 20 which provides the main LU 25 making the created copy pair in a storage system name 3222 of the new record. The management server 30 stores an identifier of the main LU 25 making the created copy pair in an LUN 3223 of the new record.

The management server 30 stores an identifier of the storage system 20 which provides the sub-LU 25 making the created copy pair in a storage system name 3224 of the new record. The management server 30 stores an identifier of the sub-LU 25 making the created copy pair in an LUN 3225 of the new record.

The management server 30 stores a synchronous rate of the created copy pair in a synchronous rate 3226 of the new record. The management server 30 stores information indicating which of a synchronous copy and an asynchronous copy is applied to the created copy pair in a copy type 3227 of the new record.

Then, the management server 30 transmits a copy pair creation notification 51 to the device link manager 127 of the host computer 10 (S103). The copy pair creation notification 51 will be described below in detail referring to FIG. 11.

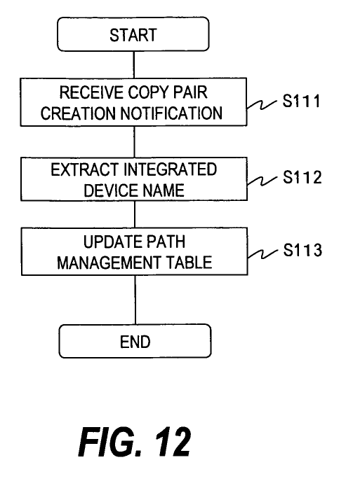

The device link manager 127 of the host computer 10 receives the copy pair creation notification 51. Then, the device link manager 127 of the host computer 10 executes a process when the copy pair creation notification is received. The process at a time when the copy pair creation notification is received will be described below in detail referring to FIG. 12.

Then, the management server 30 finishes the integrated device creation process.

FIG. 11 is a diagram showing a configuration of the copy pair creation notification 51 transmitted from the management server 30 to the host computer 10 according to the first embodiment of this invention.

The copy pair creation notification 51 indicates that a copy pair has been created. Specifically, the copy pair creation notification 51 contains notification contents 511, a copy type 512, main LU information, and sub-LU information.

The notification contents 511 indicate the contents of information transmitted from the management server 30 to the host computer 10. Accordingly, the notification contents 511 indicate that information transmitted from the management server 30 to the host computer 10 is a copy pair creation notification 51.

The copy type 512 indicates which of a synchronous copy and an asynchronous copy is applied to the created copy pair.

The main LU information contains a storage system name 513 and an LUN 514. The storage system name 513 is a unique identifier of the storage system 20 which provides the main LU 25 making the created copy pair. The LUN 514 is a unique identifier of the main LU 25 making the created copy pair.

The sub-LU information contains a storage system name 515 and an LUN 516. The storage system name 515 is a unique identifier of the storage system 20 which provides the sub-LU 25 making the created copy pair. The LUN 516 is a unique identifier of the sub-LU 25 making the created copy pair.

FIG. 12 is a flowchart showing a process when the copy pair creation notification is received by the host computer 10 according to the first embodiment of this invention.

The device link manager 127 of the host computer 10 receives a copy pair creation notification 51 (S111).

The device link manager 127 of the host computer 10 selects all the records where a storage system name 513 of the received copy pair creation notification 51 matches the storage system name 1222 of the path management table 122 from the path management table 122. The device link manager 127 of the host computer 10 selects all the records where an LUN 514 of the received copy pair creation notification 51 matches the LUN 1223 of the path management table 122 from the selected records. Accordingly, the device link manager 127 of the host computer 10 selects records regarding the main LU 25 making the created copy pair from the path management table 122.

The device link manager 127 of the host computer 10 stores information indicating the main LU 25 in a copy attribute 1226 of all the selected records. The device link manager 127 of the host computer 10 stores a copy type 512 of the received copy pair creation notification 51 in a copy type 1227 of all the selected records.

The device link manager 127 of the host computer 10 extracts an integrated device name 1228 from the selected record (S112).

Before the copy pair is created, the device link manager 127 of the host computer 10 provides only the main LU 25 making the created copy pair as an integrated device 128 identified by the extracted integrated device name 1228 to the task application 126.

The device link manager 127 of the host computer 10 selects all records where a storage system name 515 of the received copy pair creation notification 51 matches the storage system name 1222 of the path management table 122 from the path management table 122. Then, the device link manager 127 of the host computer 10 selects all records where an LUN 516 of the received copy pair creation notification 51 matches the LUN 1223 of the path management table 122 from the selected records. Accordingly, the device link manager 127 of the host computer 10 selects records regarding the sub-LU 25 making the created copy pair from the path management table 122.

The device link manager 127 of the host computer 10 stores information indicating the sub-LU 25 in copy attributes 1226 of all the selected records. The device link manager 127 of the host computer 10 stores a copy type 512 of the received copy pair creation notification 51 in copy types 1227 of all the selected records.

The device link manager 127 of the host computer 10 stores the integrated device name 1228 extracted in the step S112 in integrated device names 1228 of all the selected records.

The device link manager 127 of the host computer 10 stores information indicating that the write request cannot be transmitted by using the path 17 in write request flags 1231 of all the selected records.

The device link manager 127 of the host computer 10 judges whether the copy type 512 of the received copy pair creation notification 51 indicates a synchronous copy.

If the copy type 512 indicates a synchronous copy, the device link manager 127 stores information indicating that the read request can be transmitted by using the path 17 in read request flags 1230 of all the selected records. In other words, if a synchronous copy is applied to the copy pair, the host computer 10 is inhibited to write data in the sub-LU 25. However, the host computer 10 is permitted to read data from the sub-LU 25.

On the other hand, if the copy type 512 indicates an asynchronous copy, the device link manager 127 of the host computer 10 stores information indicating that the read request cannot be transmitted by using the path 17 in the read request flags 1230 of all the selected records. In other words, if an asynchronous copy is applied to the copy pair, all access to the sub-LU 25 from the host computer 10 is inhibited.

Thus, the device link manager 127 of the host computer 10 updates the path management table 122 (S113). The device link manager 127 of the host computer 10 finishes the process when the copy pair creation notification is received.

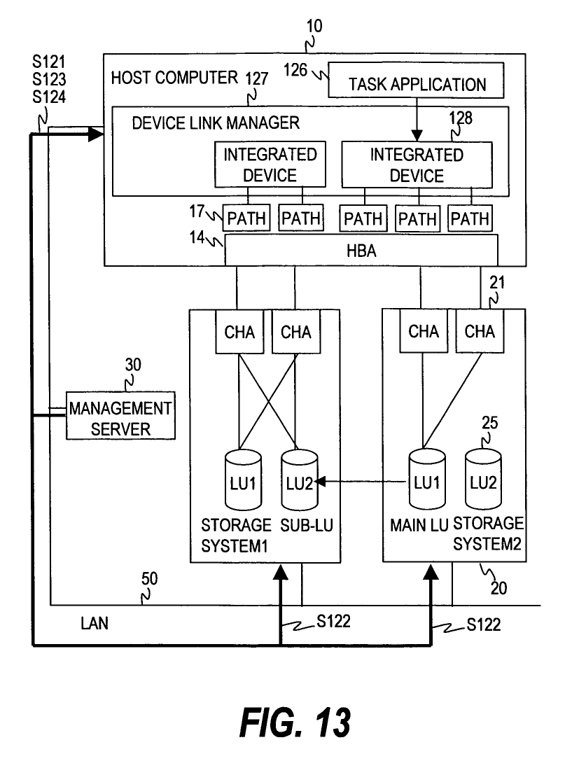

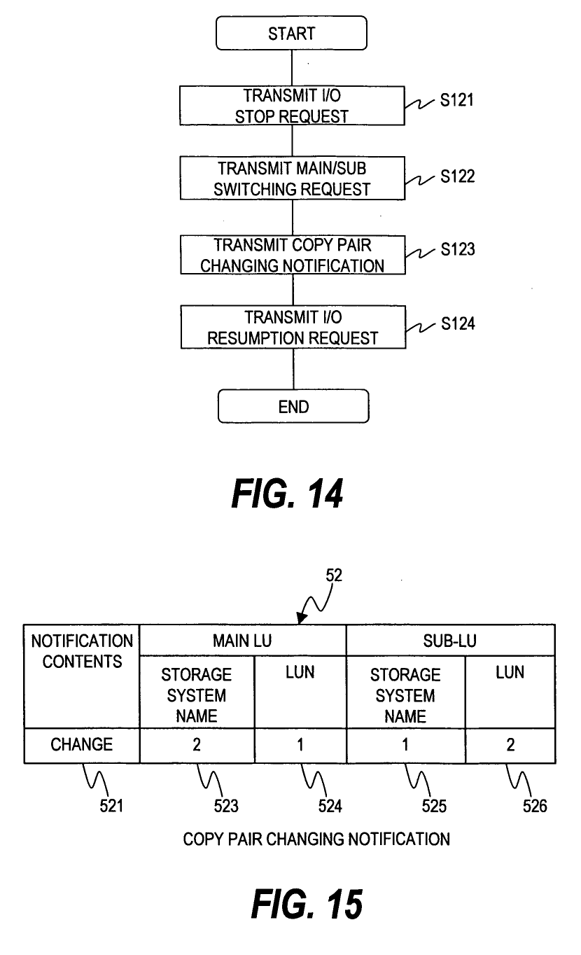

FIG. 13 is an explanatory diagram of a copy pair main/sub switching process of the management server 30 according to the first embodiment of this invention. FIG. 14 is a flowchart of the copy pair main/sub switching process of the management server 30 according to the first embodiment of this invention.

The copy pair main/sub switching process is a process for switching between the main LU 25 and the sub-LU 25. When requested to execute the copy pair main/sub switching process by the manager or the device link manager 127 of the host computer 10, the management server 30 executes the copy pair main/sub switching process.

First, the management server 30 transmits an I/O stop request for the LU 25 making a copy pair to be subjected to main/sub switching to the device link manager 127 of the host computer 10 (S121).

The device link manager 127 of the host computer 10 receives the I/O stop request. Then, the device link manager 127 of the host computer 10 stops transmission of an I/O request for the LU 25 making the copy pair of the main/sub switching target.

Then, the management server 30 transmits a copy pair main/sub switching request to the storage system 20 which provides the LU 25 making the copy pair of the main/sub switching target (S122). Specifically, the management server 30 transmits the copy pair main/sub switching request to the storage system 20 which provides the main LU 25 and the storage system 20 which provides the sub-LU 25.

The storage system 20 receives the copy pair main/sub switching request. Then, the storage system 20 switches between the main LU 25 and the sub-LU 25. Accordingly, the storage system 20 copies data written in the main LU 25 after main/sub switching in the sub-LU 25 after the main/sub switching.

The management server 30 updates the copy pair management table 322.

Specifically, the management server 30 selects a record where an identifier of the copy pair of the main/sub switching target matches the copy pair name 3221 of the copy pair management table 322 from the copy pair management table 322. Then, the management server 30 substitutes the storage system name 3224 of the selected record with a storage system name 3222 of the selected record. The management server 30 substitutes the LUN 3225 of the selected record with an LUN 3223 of the selected record.

The management server 30 transmits a copy pair changing notification 52 to the device link manager 127 of the host computer 10 (S123). The copy pair changing notification 52 will be described below in detail referring to FIG. 15.

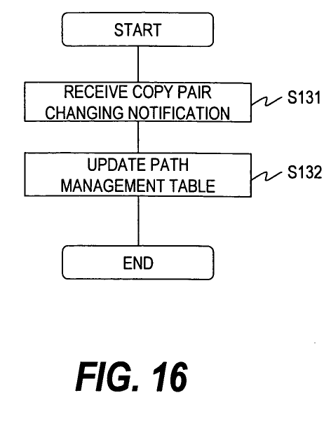

The device link manager 127 of the host computer 10 receives the copy pair changing notification 52. Then, the device link manager 127 of the host computer 10 executes a process when the copy pair changing notification is received. The process at a time when the copy pair changing notification is received will be described below in detail referring to FIG. 16.

The management server 30 transmits an I/O resume request for the LU 25 making the main/sub-switched copy pair to the device link manager 127 of the host computer 10 (S124).

The device link manager 127 of the host computer 10 receives the I/O resume request. Then, the device link manager 127 of the host computer 10 resumes transmission of the I/O request to the LU 25 making the main/sub switched copy pair.

The management server 30 finishes the copy pair main/sub switching process.

FIG. 15 is a diagram showing a configuration of the copy pair changing notification 52 transmitted from the management server 30 to the host computer 10 according to the first embodiment of this invention.

The copy pair changing notification 52 indicates that the main LU 25 and the sub-LU 25 making the copy pair have been switched with each other. Specifically, the copy pair changing notification 52 contains notification contents 521, main LU information, and sub-LU information.

The notification contents 521 indicate the contents of information transmitted from the management server 30 to the host computer 10. Accordingly, the notification contents 521 indicate that information transmitted from the management server 30 to the host computer 10 is a copy pair changing notification 52.

The main LU information contains a storage system name 523 and an LUN 524. The storage system name 523 is a unique identifier of the storage system 20 which provides the main LU 25 after main/sub switching. The LUN 524 is a unique identifier of the main LU 25 after the main/sub switching.

The sub-LU information contains a storage system name 525 and an LUN 526. The storage system name 525 is a unique identifier of the storage system 20 which provides the sub-LU 25 after the main/sub switching. The LUN 526 is a unique identifier of the sub-LU 25 after the main/sub switching.

FIG. 16 is a flowchart of a process when the host computer 10 receives the copy pair changing notification according to the first embodiment of this invention.

The device link manager 127 of the host computer 10 receives the copy pair changing notification 52 (S131).

The device link manager 127 of the host computer 10 selects all records where a storage system name 523 of the received copy pair changing notification 52 matches the storage system name 1222 of the path management table 122 from the path management table 122. Then, the device link manager 127 of the host computer 10 selects all records where an LUN 524 of the received copy pair changing notification 52 matches the LUN 1223 of the path management table 122 from the selected records. Accordingly, the device link manager 127 of the host computer 10 selects records regarding the main LU 25 after the main/sub switching from the path management table 122.

The device link manager 127 of the host computer 10 stores information indicating the main LU 25 in copy attributes 1226 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

The device link manager 127 of the host computer 10 selects all records where a storage system name 525 of the received copy pair changing notification 52 matches the storage system name 1222 of the path management table 122 from the path management table 122. The device link manager 127 of the host computer 10 selects all records where an LUN 526 of the received copy pair changing notification 52 matches the LUN 1223 of the path management table 122 from the selected records. Accordingly, the device link manager 127 of the host computer 10 selects records regarding the sub-LU 25 after main/sub switching from the path management table 122.

The device link manager 127 of the host computer 10 stores information indicating the sub-LU 25 in copy attributes 1226 of all the selected records. The device link manager 127 of the host computer 10 stores information indicating that the write request cannot be transmitted by using the path 17 in write request flags 1231 of all the selected records.

The device link manager 127 of the host computer 10 judges whether a copy type 1227 of the selected record indicates a synchronous copy. If the copy type 1227 indicates a synchronous copy, the device link manager 127 of the host computer 10 stores information indicating that the read request can be transmitted by using the path 17 in read request flags 1230 of all the selected records. On the other hand, if the copy type 1227 indicates an asynchronous copy, the device link manager 127 of the host computer 10 stores information indicating that the read request cannot be transmitted by using the path 17 in the read request flags 1230 of all the selected records.

Thus, the device link manager 127 of the host computer 10 updates the path management table 122 (S132). Then, the device link manager 127 of the host computer 10 finishes the process when the copy pair changing notification is received.

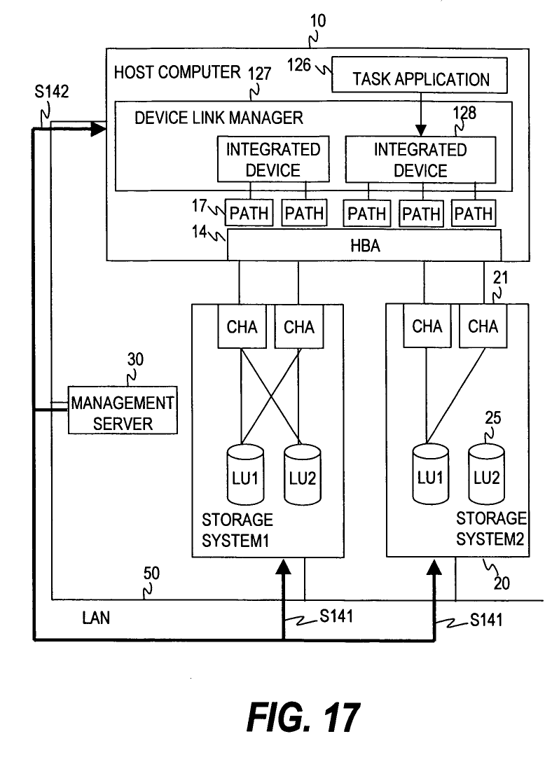

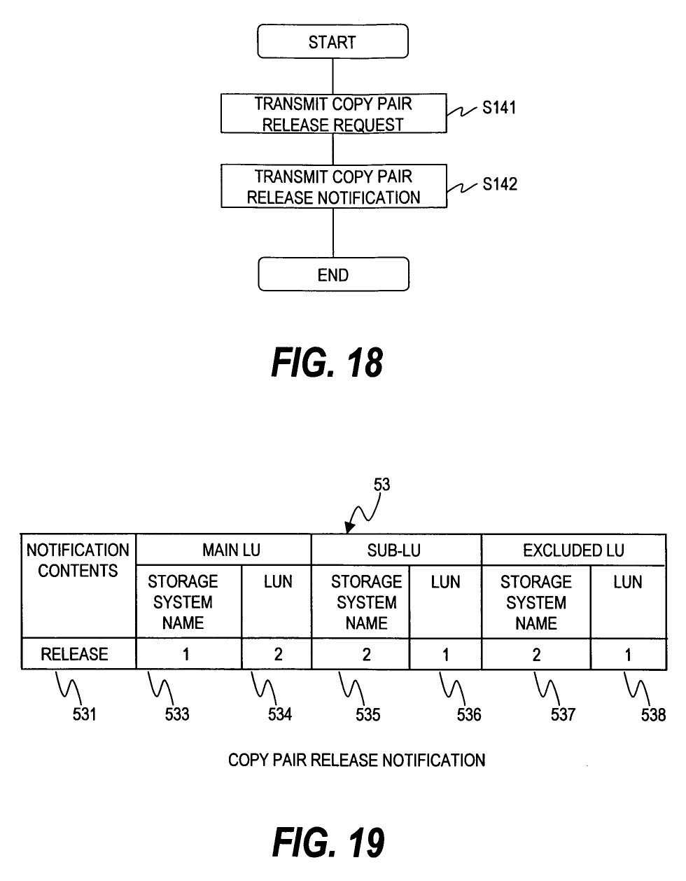

FIG. 17 is an explanatory diagram of an integrated device releasing process of the management server 30 according to the first embodiment of this invention. FIG. 18 is a flowchart of the integrated device releasing process of the management server 30 according to the first embodiment of this invention.

When requested to execute the integrated device releasing process from the manager or the device link manager 127 of the host computer 10, the management server 30 executes the integrated device releasing process.

First, the management server 30 transmits a copy pair release request to the storage system 20 which provides the LU 25 as an integrated device 128 to be released (S141). Specifically, the management server 30 transmits the copy pair release request to the storage system 20 which provides the main LU 25 and the storage system 20 which provides the sub-LU 25.

The storage system 20 receives the copy pair release request. Then, the storage system 20 releases the copy pair. Specifically, the storage system 20 stops copying data written in the main LU 25 to the sub-LU 25.

Then, the management server 30 updates the copy pair management table 322.

Specifically, the management server 30 deletes records where an identifier of a released copy pair matches the copy pair name 3221 of the copy pair management table 322 from the copy pair management table 322.

Then, the management server 30 transmits a copy pair release notification 53 to the device link manager 127 of the host computer 10 (S142). The copy pair release notification 53 will be described below in detail referring to FIG. 19.

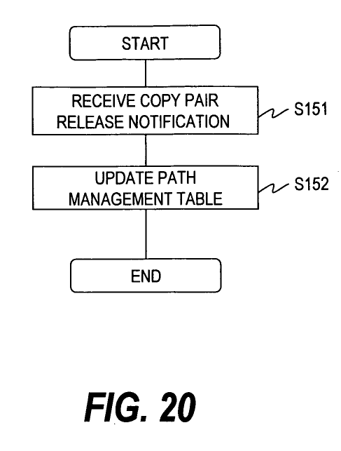

The device link manager 127 of the host computer 10 receives the copy pair release notification 53. Then, the device link manager 127 of the host computer 10 executes a process when the copy pair release notification is received. The process at a time when the copy pair release notification is received will be described below in detail referring to FIG. 20.

The management server 30 finishes the integrated device releasing process.

FIG. 19 is a diagram showing a configuration of the copy pair release notification 53 transmitted from the management server 30 to the host computer 10 according to the first embodiment of this invention.

The copy pair release notification 53 indicates that the copy pair has been released. Specifically, the copy pair release notification 53 contains notification contents 531, main LU information, sub-LU information, and excluded LU information.

The notification contents 531 indicate the contents of information transmitted from the management server 30 to the host computer 10. Accordingly, the notification contents 531 indicate that information transmitted from the management server 30 to the host computer 10 is a copy pair release notification 53.

The main LU information contains a storage system name 533 and an LUN 534. The storage system name 533 is a unique identifier of the storage system 20 which provides the main LU 25 before copy pair releasing. The LUN 534 is a unique identifier of the main LU 25 before copy pair releasing.

The sub-LU information contains a storage system name 535 and an LUN 536. The storage system name 535 is a unique identifier of the storage system 20 which provides the sub-LU 25 before copy pair releasing. The LUN 536 is a unique identifier of the sub-LU 25 before copy pair releasing.

The excluded LU information contains a storage system name 537 and an LUN 538. The storage system name 537 is a unique identifier of the storage system 20 which provides an LU 25 included in the LU's 25 making the released copy pair but excluded from the integrated device 128. The LUN 538 is a unique identifier of the LU 25 included in the LU's 25 making the released copy pair but excluded from the integrated device 128.

FIG. 20 is a flowchart of a process when the host computer 10 receives the copy pair release notification according to the first embodiment of this invention.

The device link manager 127 of the host computer 10 receives the copy pair release notification 53 (S151).

The device link manager 127 of the host computer 10 selects all records where a storage system name 533 of the received copy pair release notification 53 matches the storage system name 1222 of the path management table 122 from the path management table 122. Then, the device link manager 127 of the host computer 10 selects all records where an LUN 534 of the received copy pair release notification 53 matches the LUN 1223 of the path management table 122 from the selected records. Accordingly, the device link manager 127 of the host computer 10 selects records regarding the main LU 25 before copy pair releasing from the path management table 122.

The device link manager 127 of the host computer 10 deletes copy attributes 1226 and copy types 1227 of all the selected records. Then, the device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

The device link manager 127 of the host computer 10 selects all records where a storage system name 535 of the received copy pair release notification 53 matches the storage system name 1222 of the path management table 122 from the path management table 122. The device link manager 127 of the host computer 10 selects all records where an LUN 536 of the received copy pair release notification 53 matches the LUN 1223 of the path management table 122 from the selected records. Accordingly, the device link manager 127 of the host computer 10 selects records regarding the sub-LU 25 before copy pair releasing from the path management table 122.

The device link manager 127 of the host computer 10 deletes copy attributes 1226 and copy types 1227 of all the selected records. Then, the device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

The device link manager 127 of the host computer 10 selects all records where a storage system name 537 of the received copy pair release notification 53 matches the storage system name 1222 of the path management table 122 from the path management table 122. The device link manager 127 of the host computer 10 selects all records where an LUN 538 of the received copy pair release notification 53 matches the LUN 1223 of the path management table 122 from the selected records. Accordingly, the device link manager 127 of the host computer 10 selects records regarding the LU 25 excluded from the integrated device 128 from the path management table 122.

The device link manager 127 of the host computer 10 stores the same value not overlapping with the integrated device names 1228 of all the records included in the path management table 122 in integrated device names 1228 of all the selected records. Accordingly, the device link manager 127 of the host computer 10 does not use the path 17 connected to the LU 25 excluded from the integrated device 128 any more for transmitting the I/O request issued from the task application 126 to the integrated device 128.

Thus, the device link manager 127 of the host computer 10 updates the path management table 122 (S152). Then, the device link manager 127 of the host computer 10 finishes the process when the copy pair release notification is received.

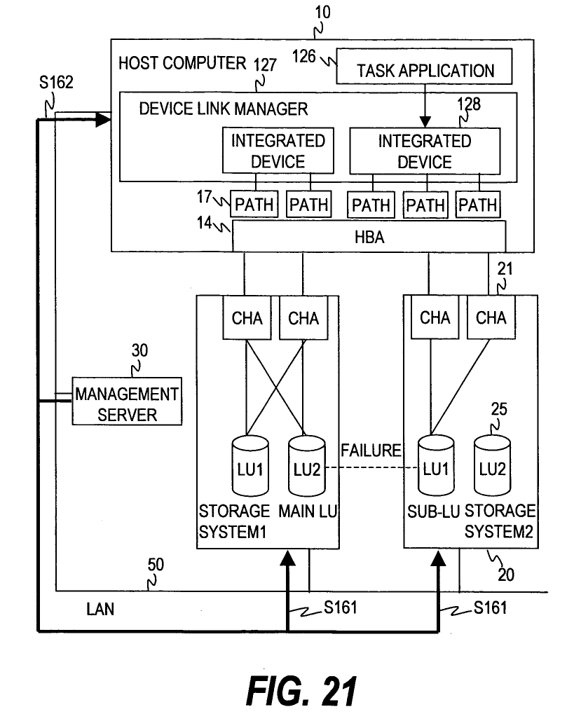

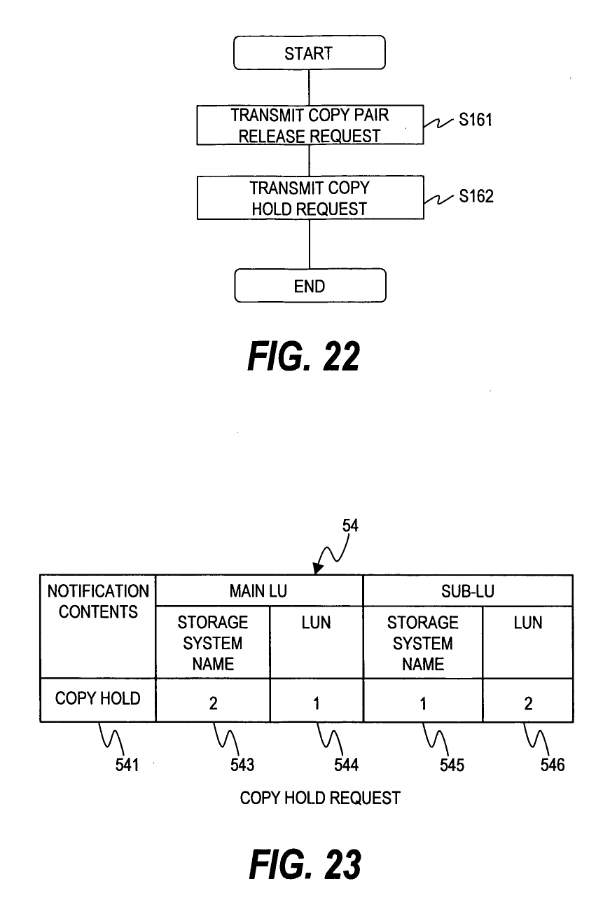

FIG. 21 is an explanatory diagram of a copy holding process of the management server 30 according to the first embodiment of this invention. FIG. 22 is a flowchart of the copy holding process of the management server 30 according to the first embodiment of this invention.

When requested to execute the copy holding process from the manager or the device link manager 127 of the host computer 10, the management server 30 executes the copy holding process.

Even when data written in the main LU 25 cannot be copied to the sub-LU 25, the management server 30 executes the copy holding process. For example, when a failure occurs in a path (copy path) for interconnecting the main LU 25 and the sub-LU 25, the management server 30 executes the copy holding process.

First, the management server 30 transmits a copy pair release request to the storage system 20 which provides the LU 25 provided as an integrated device 128 (S161). Specifically, the management server 30 transmits the copy pair release request to the storage system 20 which provides the main LU 25 and the storage system 20 which provides the sub-LU 25.

The storage system 20 receives the copy pair release request. Then, the storage system 20 releases the copy pair. Specifically, the storage system 20 stops copying data written in the main LU 25 to the sub-LU 25.

Then, the management server 30 updates the copy pair management table 322.

Specifically, the management server 30 deletes records where an identifier of a released copy pair matches the copy pair name 3221 of the copy pair management table 322 from the copy pair management table 322.

Then, the management server 30 transmits a copy holding request 54 to the device link manager 127 of the host computer 10 (S162). The copy holding request 54 will be described below in detail referring to FIG. 23.

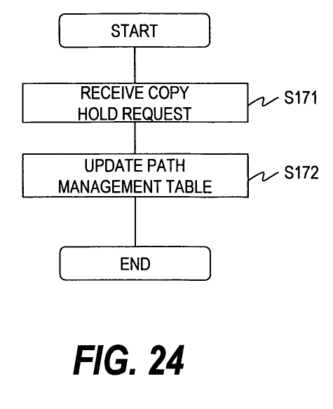

The device link manager 127 of the host computer 10 receives the copy holding request 54. Then, the device link manager 127 of the host computer 10 executes a process when the copy holding request is received. The process at a time when the copy holding request is received will be described below in detail referring to FIG. 24.

The management server 30 finishes the copy holding process.

FIG. 23 is a diagram showing a configuration of the copy holding request 54 transmitted from the management server 30 to the host computer 10 according to the first embodiment of this invention.

The copy holding request 54 requests that data of all the LU's 25 provided as identical integrated devices 128 be identically held. In other words, the copy holding request 54 requests that data of the main LU 25 and that of the sub-LU 25 before copy pair releasing be identically held.

Specifically, the copy holding request 54 contains notification contents 541, main LU information, and sub-LU information.

The notification contents 541 indicate the contents of information transmitted from the management server 30 to the host computer 10. Accordingly, the notification contents 541 indicate that information transmitted from the management server 30 to the host computer 10 is a copy holding request 54.

The main LU information contains a storage system name 543 and an LUN 544. The storage system name 543 is a unique identifier of the storage system 20 which provides the main LU 25 before copy pair releasing. The LUN 544 is a unique identifier of the main LU 25 before copy pair releasing.

The sub-LU information contains a storage system name 545 and an LUN 546. The storage system name 545 is a unique identifier of the storage system 20 which provides the sub-LU 25 before copy pair releasing. The LUN 546 is a unique identifier of the sub-LU 25 before copy pair releasing.

FIG. 24 is a flowchart of a process when the host computer 10 receives the copy holding request according to the first embodiment of this invention.

The device link manager 127 of the host computer 10 receives the copy holding request 54 (S171).

The device link manager 127 of the host computer 10 selects all records where a storage system name 543 of the received copy holding request 54 matches the storage system name 1222 of the path management table 122 from the path management table 122. Then, the device link manager 127 of the host computer 10 selects all records where an LUN 544 of the received copy holding request 54 matches the LUN 1223 of the path management table 122 from the selected records. Accordingly, the device link manager 127 of the host computer 10 selects records regarding the main LU 25 before copy pair releasing from the path management table 122.

The device link manager 127 of the host computer 10 deletes copy attributes 1226 and copy types 1227 of all the selected records. Then, the device link manager 127 of the host computer 10 stores information indicating a copy path failure in statuses 1229 of all the selected records. The copy path failure is a status where data written in the main LU 25 cannot be copied to the sub-LU 25.

The device link manager 127 of the host computer 10 selects all records where a storage system name 545 of the received copy holding request 54 matches the storage system name 1222 of the path management table 122 from the path management table 122. The device link manager 127 of the host computer 10 selects all records where an LUN 546 of the received copy holding request 54 matches the LUN 1223 of the path management table 122 from the selected records. Accordingly, the device link manager 127 of the host computer 10 selects records regarding the sub-LU 25 before copy pair releasing from the path management table 122.

The device link manager 127 of the host computer 10 deletes copy attributes 1226 and copy types 1227 of all the selected records. Then, the device link manager 127 of the host computer 10 stores information indicating a copy path failure in statuses 1229 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

Accordingly, the device link manager 127 of the host computer 10 transmits the I/O request issued from the task application 126 to the integrated device 128 to all the LU's 25 provided as the integrated devices 128.

Thus, the device link manager 127 of the host computer 10 updates the path management table 122 (S172). Then, the device link manager 127 of the host computer 10 finishes the process when the copy holding request is received.

According to the embodiment of this invention, the storage system 20 can be replaced through the aforementioned process. A case where a currently operated storage system (old storage system) 20 is replaced by a new storage system 20 will be described.

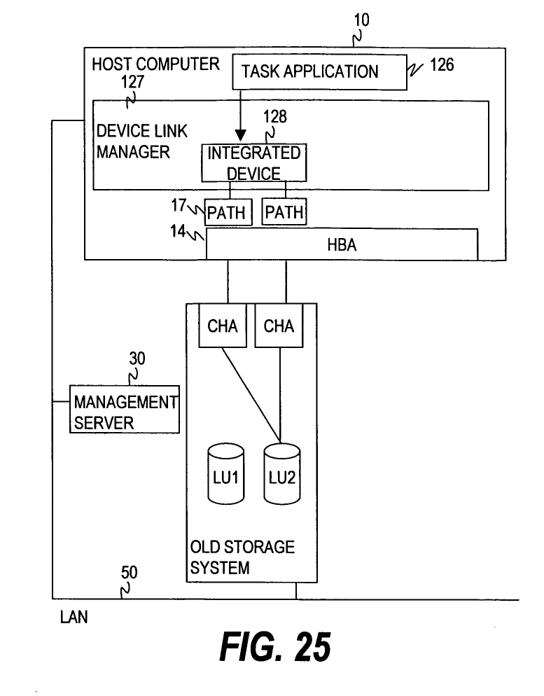

FIG. 25 is an explanatory diagram of a storage system replacing process of the computer system according to the first embodiment of this invention.

FIG. 25 shows a status before the storage system replacing process is executed.

Before the storage system is replaced, the device link manager 127 of the host computer 10 provides one LU 25 of the old storage system 20 as one integrated device 128 to the task application 126. Accordingly, the device link manager 127 of the host computer 10 transmits an I/O request issued from the task application 126 to the integrated device 128 to the old storage system 20 by using the path 17 connected to the LU 25 provided as the integrated device 128.

First, in the storage system replacing process, a new storage system 20 is added to the computer system 10. Then, the management server 30 executes an integrated device creation process (FIGS. 9 and 10).

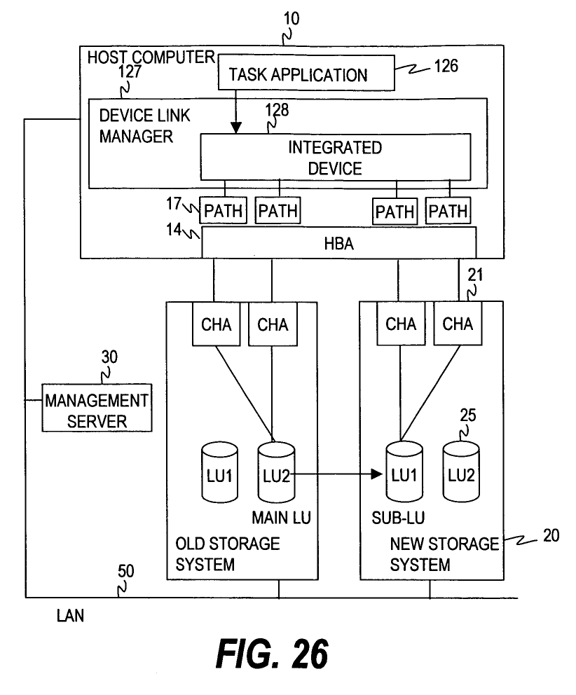

FIG. 26 is an explanatory diagram of the storage system replacing process of the computer system according to the first embodiment of this invention.

FIG. 26 shows a status after the management server 30 executes the integrated device creation process.

After the execution of the integrated device creation process, the LU 25 of the old storage system 20 and the LU 25 of the new storage system 20 make a copy pair. In this case, the LU 25 of the old storage system 20 is a main LU 25. The LU 25 of the new storage system 20 is a sub-LU 25.

The device link manager 127 of the host computer 10 provides the main LU 25 and the sub-LU 25 making one copy pair as one integrated device 128 to the task application 126. In other words, the device link manager 127 of the host computer 10 provides the main LU 25 of the old storage system and the sub-LU 25 of the new storage system as one integrated device 128 to the task application 126.

Then, in the storage system replacing process, the management server 30 executes a copy pair main/sub switching process (FIGS. 13 and 14).

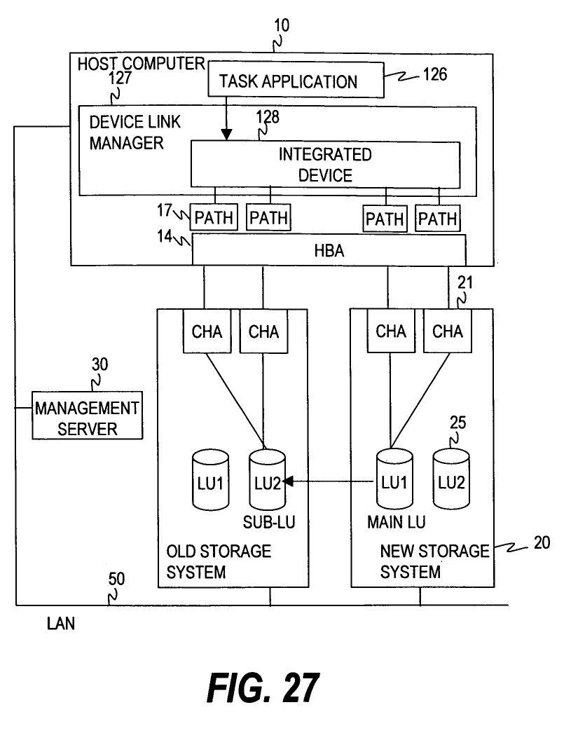

FIG. 27 is an explanatory diagram of the storage system replacing process of the computer system according to the first embodiment of this invention.

FIG. 27 shows a status after the management server 30 executes the copy pair main/sub switching process.

By executing the copy pair main/sub switching process, the main LU 25 is switched to the sub-LU 25. Accordingly, after the execution of the copy pair main/sub switching process, the LU 25 of the old storage system 20 is a sub-LU 25. The LU 25 of the new storage system 20 is a main LU 25.

Then, in the storage system replacing process, the management server 30 executes an integrated device releasing process (FIGS. 17 and 18).

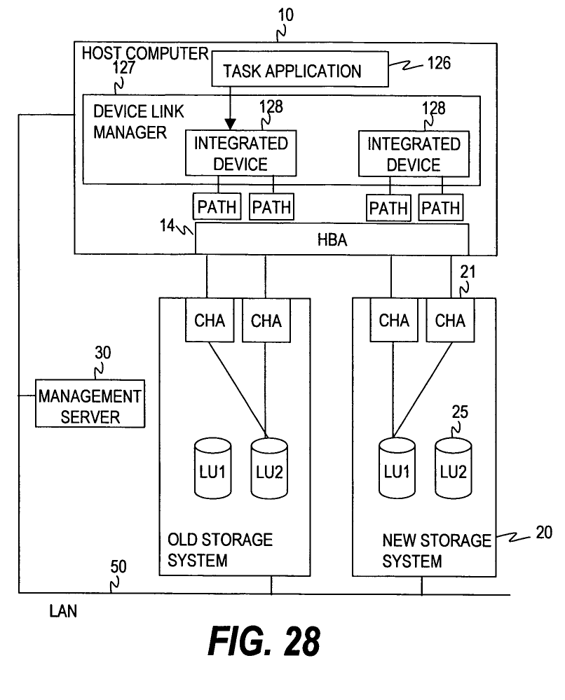

FIG. 28 is an explanatory diagram of the storage system replacing process of the computer system according to the first embodiment of this invention.

FIG. 28 shows a status after the management server 30 executes the integrated device releasing process.

By executing the integrated device releasing process, the copy pair which includes the LU 25 of the old storage system 20 and the LU 25 of the new storage system 20 is released.

The device link manager 127 of the host computer 10 provides the LU 25 of the old storage system 20 as a new integrated device 128 to the task application 126. The device link manager 127 of the host computer 10 provides the LU 25 of the new storage system 20 as an integrated device 128 provided before the execution of the storage system replacing process to the task application 126.

Then, in the storage system replacing process, the old storage system 20 is removed from the computer system. Accordingly, the computer system finishes the storage system replacing process.

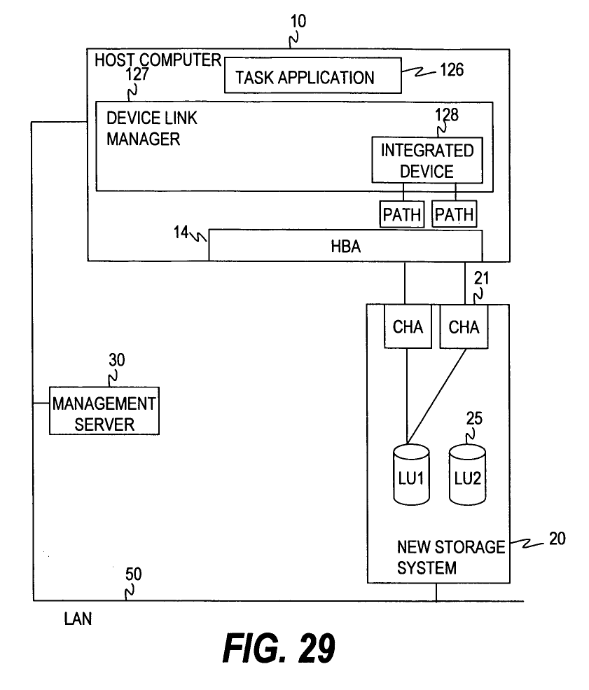

FIG. 29 is an explanatory diagram of the storage system replacing process of the computer system according to the first embodiment of this invention.

FIG. 29 shows a status after the storage system replacing process is executed.

After the execution of the storage system replacing process, the device link manager 127 of the host computer 10 provides one LU 25 of the new storage system 20 as one integrated device 128 to the task application 126. Accordingly, the device link manager 127 of the host computer 10 transmits an I/O request issued from the task application 126 to the integrated device 128 to the new storage system 20 by using the path 17 connected to the LU 25 provided as the integrated device 128.

According to the embodiment, the device link manager 127 of the host computer 10 switches the LU 25 provided as the integrated device 128 to the task application 126 from the LU 25 of the old storage system to the LU 25 of the new storage system. In this case, the device link manager 127 of the host computer 10 switches the LU 25 provided as the integrated device 128 to the task application 126 without being sensed by the task application 126 of the host computer 10. Thus, it is not necessary to change setting of the task application 126 of the host computer 10.

Next, a process when a failure occurs in the computer system according to the embodiment of this invention will be described.

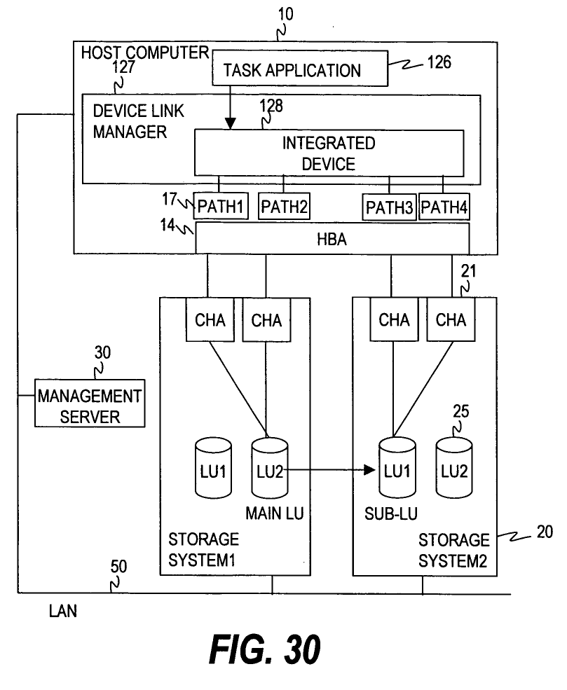

FIG. 30 is an explanatory diagram of the computer system at a normal time according to the first embodiment of this invention.

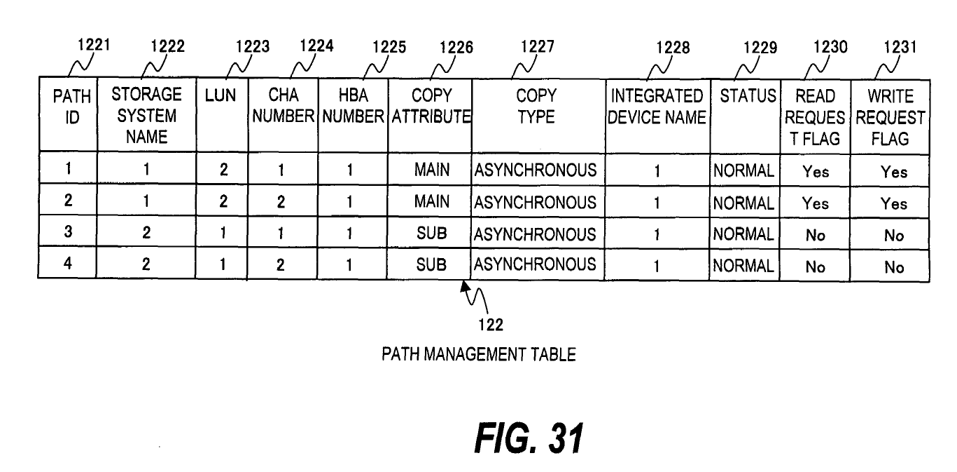

FIG. 31 is a diagram of the path management table 122 stored in the host computer 10 at normal times according to the first embodiment of this invention.

Each of FIGS. 30 and 31 shows a status before a failure occurs (normal time).

Referring to FIGS. 30 and 31, the storage system 20 identified by “1” of a storage system name 1222 provides a main LU 25 identified by “2” of an LUN 1223. The storage system 20 identified by “2” of the storage system name 1222 provides a sub-LU 25 identified by “1” of the LUN 1223. The main LU 25 and the sub-LU 25 makes a copy pair. Accordingly, data written in the main LU 25 is copied to the sub-LU 25.

The device link manager 127 of the host computer 10 transmits an I/O request issued from the task application 126 to the integrated device 128 to the storage system 20 by using the path 17 connected to the main LU 25 provided as the integrated device 128. In other words, the device link manager 127 of the host computer 10 transmits the I/O request only to the storage system 20 which includes the main LU 25.

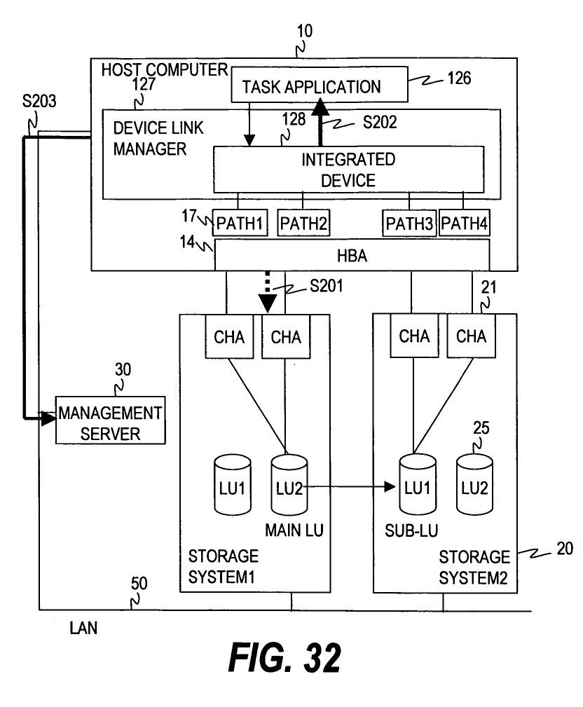

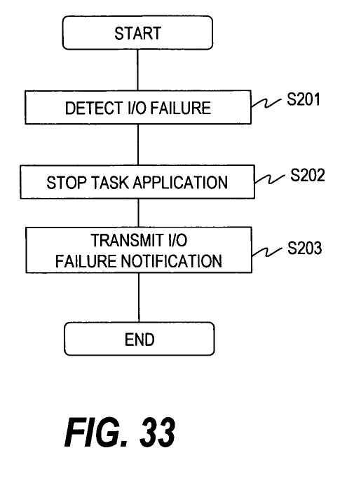

FIG. 32 is an explanatory diagram of a process when the device link manager 127 of the host computer 10 detects a failure according to the first embodiment of this invention. FIG. 33 is a flowchart of the process when the device link manager 127 of the host computer 10 detects a failure according to the first embodiment of this invention.

Upon detection of an I/O failure (S201), the device link manager 127 of the host computer 10 executes the process when the failure is detected. For example, the device link manager 127 of the host computer 10 judges an I/O failure when the number of transmission errors of an I/O request exceeds a threshold value. The device link manager 127 of the host computer 10 judges an I/O failure when the number of closed paths among the paths 17 connected to the transmission destination LU 25 of the I/O request exceeds a threshold value.

Upon detection of the I/O failure, the device link manager 127 of the host computer 10 specifies an integrated device 128 corresponding to the I/O failure. Then, the device link manager 127 of the host computer 10 stops the task application 126 which issues an I/O request to the specified integrated device 128 (S202).

Then, the device link manager 127 of the host computer 10 transmits an I/O failure notification to the management server 30 (S203). The device link manager 127 of the host computer 10 finishes the process when the failure is detected.

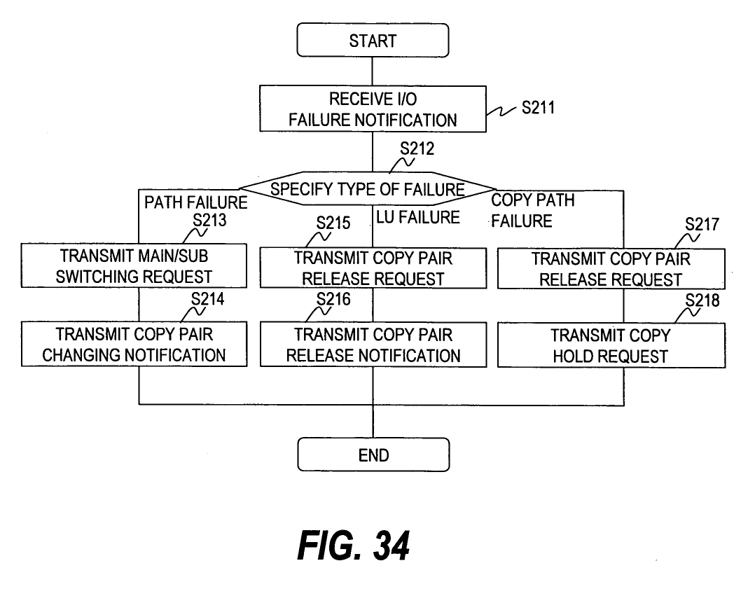

FIG. 34 is a flowchart of a process when the management server 30 receives the I/O failure notification according to the first embodiment of this invention.

Upon reception of the I/O failure notification from the host computer 10 (S211), the management server 30 executes the process when the I/O failure notification is received.

First, the management server 30 obtains a pair status of a copy pair which includes the I/O failed LU 25 from the storage system 20. Then, the management server 30 specifies a cause of the notified I/O failure based on the pair status.

Specifically, the management server 30 specifies which of a failure of the path 17, a failure of the LU 25, and a copy path failure the cause of the notified I/O failure is (S212).

If the cause of the I/O failure is a failure of the path 17, a failure has occurred in the path 17 for interconnecting the host computer 10 and the main LU 25. In this case, because there is no failure in the copy path, the operation of the computer system can be continued while a copy status between the main LU 25 and the sub-LU 25 is maintained.

Accordingly, the management sever 30 transmits a copy pair main/sub switching request to the storage system 20 (S213). Specifically, the management server 30 transmits a copy pair main/ sub switching request to the storage device 20 which provides the main LU 25 and the storage system 20 which provides the sub-LU 25.

The storage system 20 receives the copy pair main/sub switching request. Then, the storage system 20 switches the main LU 25 to the sub-LU 25. Accordingly, the storage system 20 copies data written in the main LU 25 after main/sub switching to the sub-LU 25 after the main/sub switching.

Then, the management server 30 updates the copy pair management table 322.

Specifically, the management server 30 selects a record where an identifier of the main/sub-switched copy pair matches the copy pair name 3221 of the copy pair management table 322 from the copy pair management table 322. Then, the management server 30 substitutes the storage system name 3224 of the selected record with storage system name 3222 of the selected record. The management server 30 substitutes the LUN 3225 of the selected record with LUN 3223 of the selected record.

The management server 30 creates a copy pair changing notification 52 (FIG. 15) based on the copy pair management table 322 after updating.

Specifically, the management server 30 stores a storage system name 3222 of the record selected from the copy pair management table 322 in the storage system name 523 of the copy pair changing notification 52. The management server 30 stores an LUN 3223 of the record selected from the copy pair management table 322 in the LUN 524 of the copy pair changing notification 52. The management server 30 stores a storage name 3224 of the record selected from the copy pair management table 322 in the storage system name 525 of the copy pair changing notification 52. The management server 30 stores an LUN 3225 of the record selected from the copy pair management table 322 in the LUN 526 of the copy pair changing notification 52.

The management server 30 transmits the created copy pair changing notification 52 to the device link manager 127 of the host computer 10 (S214). Then, the management server 30 finishes the process when the I/O failure notification is received.

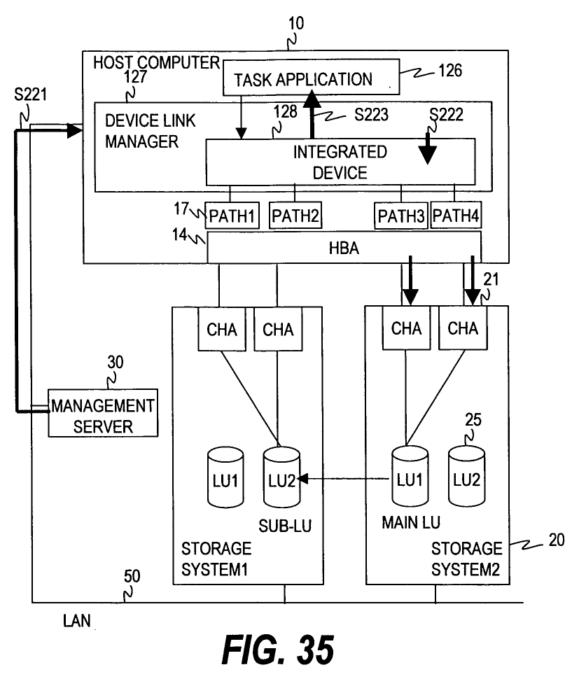

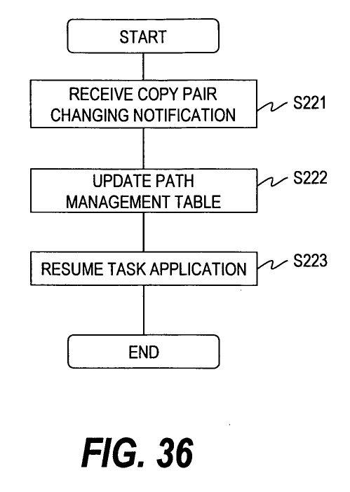

The device link manager 127 of the host computer 10 receives the copy pair changing notification 52. The device link manager 127 of the host computer 10, which has received the copy pair changing notification 52 after transmission of the I/O failure notification, executes a process at a time when a path failure occurs. The process when the path failure occurs will be described below in detail referring to FIGS. 35 and 36.

On the other hand, if the cause of the I/O failure is a failure of the LU 25, a failure has occurred in the main LU 25 of the storage system 20. In this case, access is inhibited to the main LU 25 of the storage system 20. Accordingly, a copy status cannot be maintained between the main LU 25 and the sub-LU 25. However, through access of the host computer 10 to the sub-LU 25, the operation of the computer system can be continued.

Then, the management server 30 transmits a copy pair release request to the storage system 20 which provides the failed main LU 25 and the storage system 20 which provides the sub-LU 25 making the copy pair with the failed main LU 25 (S215).

The storage system 20 receives the copy pair release request. Then, the storage system 20 releases the copy pair.

Then, the management server 30 updates the copy pair management table 322.

Specifically, the management server 30 deletes records where an identifier of the released copy pair matches the copy pair name 3221 of the copy pair management table 322 from the copy pair management table 322.

Then, the management server 30 creates a copy pair release notification 53 (FIG. 19).

Specifically, the management server 30 stores an identifier of the storage system 20 which provides a failed main LU 25 in storage system names 533 and 537 of the copy pair release notification 53. The management server 30 stores an identifier of the failed main LU 25 in the LUN's 534 and 538 of the copy pair release notification 53. The management server 30 stores an identifier of the storage system 20 which provides a sub-LU 25 making a copy pair with the failed main LU 25 in the storage system name 535 of the copy pair release notification 53. The management server 30 stores an identifier of the sub-LU 25 making the copy pair with the failed main LU 25 in the LUN 536 of the copy pair release notification 53.

Then, the management server 30 transmits the created copy pair release notification 53 to the device link manager 127 of the host computer 10 (S216). The management server 30 finishes the process when the I/O failure notification is received.

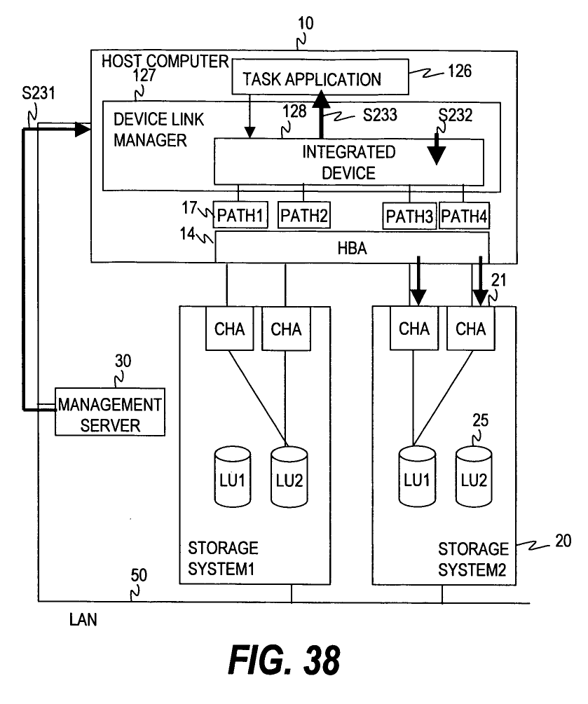

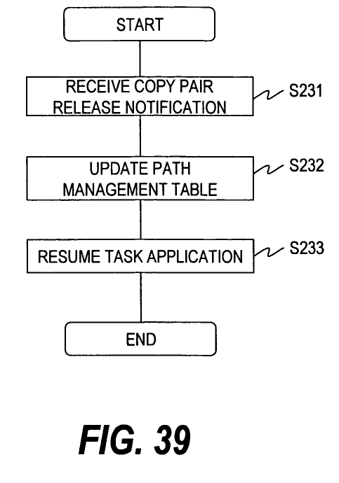

The device link manager 127 of the host computer 10 receives the copy pair release notification 53. The device link manager 127 of the host computer 10, which has received the copy pair release notification 53 after the transmission of the I/O failure notification, executes a process when an LU failure occurs. The process when the LU failure occurs will be described in detail referring to FIGS. 38 and 39.

On the other hand, if the cause of the I/O failure is a failure of the copy path, a failure has occurred in the copy path for interconnecting the main LU 25 and the sub-LU 25. In this case, the host computer 10 can access both of the main LU 25 of the storage system 20 and the sub-LU 25 of the storage system 20. However, data of the main LU 25 cannot be copied to the sub-LU 25. Accordingly, the host computer 10 writes data in both of the main LU 25 and the sub-LU 25. Thus, the operation of the computer system can be continued while a copy status is maintained between the main LU 25 and the sub-LU 25.

The management server 30 transmits a copy pair release request to the storage system 20 which provides the main LU 25 connected to the failed copy path and the storage system 20 which provides the sub-LU 25 connected to the failed copy path (S217).

The storage system 20 receives the copy pair release request. Then, the storage system 20 releases the copy pair.

The management server 30 updates the copy pair management table 322.

Specifically, the management server 30 deletes a record where an identifier of the released copy pair matches the copy pair name 3221 of the copy pair management table 322 from the copy pair management table 322.

Then, the management server 30 creates a copy holding request 54 (FIG. 23).

Specifically, the management server 30 stores an identifier of the storage system 20 which provides the main LU 25 connected to the failed copy path in the storage system name 543 of the copy holding request 54. The management server 30 stores an identifier of the main LU 25 connected to the failed copy path in the LUN 544. The management server 30 stores an identifier of the storage system 20 which provides the sub-LU 25 connected to the failed copy path in the storage system name 545. The management server 30 stores an identifier of the sub-LU 25 connected to the failed copy path in the LUN 546.

Then, the management server 30 transmits the created copy holding request 54 to the device link manager 127 of the host computer 10 (S218). The management server 30 finishes the process when the I/O failure notification is received.

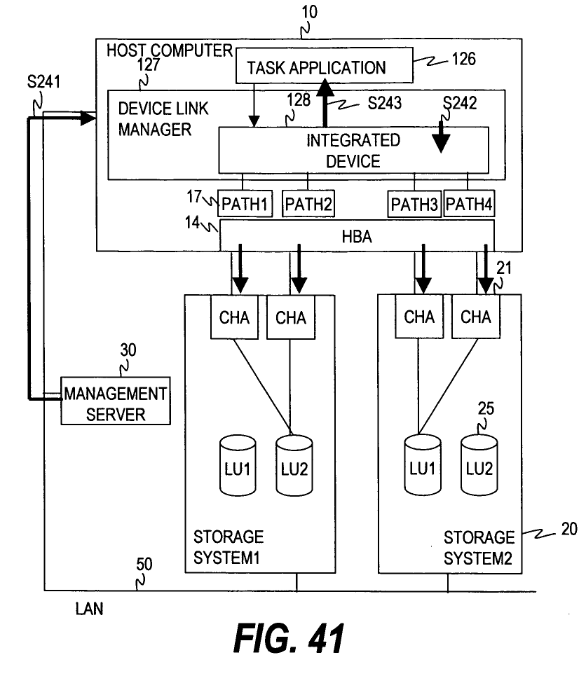

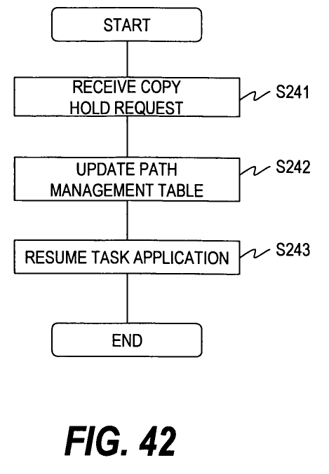

The device link manager 127 of the host computer 10 receives the copy holding request 54. The device link manager 127 of the host computer 10, which has received the copy holding request 54 after the transmission of the I/O failure notification, executes a process when a copy path failure occurs. The process when the copy path failure occurs will be described in detail referring to FIGS. 41 and 42.

FIG. 35 is an explanatory diagram of a process executed by the host computer 10 when a path failure occurs according to the first embodiment of this invention. FIG. 36 is a flowchart of the process executed by the host computer 10 when the path failure occurs according to the first embodiment of this invention.

The device link manager 127 of the host computer 10 receives a copy pair changing notification 52 (S221).

Then, the device link manager 127 of the host computer 10 selects all records where a storage system name 523 of the received copy pair changing notification 52 matches the storage system name 1222 of the path management table 122 from the path management table 122. The device link manager 127 of the host computer 10 selects all records where an LUN 524 of the received copy pair changing notification 52 matches the LUN 1223 of the path management table 122 from the selected records. Accordingly, the device link manager 127 of the host computer 10 selects records regarding the main LU 25 after main/sub switching from the path management table 122.

The device link manager 127 of the host computer 10 stores information indicating the main LU 25 in copy attributes 1226 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

The device link manager 127 of the host computer 10 selects all records where a storage system name 525 of the received copy pair changing notification 52 matches the storage system name 1222 of the path management table 122 from the path management table 122. The device link manager 127 of the host computer 10 selects all records where an LUN 526 of the received copy pair changing notification 52 matches the LUN 1223 of the path management table 122 from the selected records. Accordingly, the device link manager 127 of the host computer 10 selects records regarding the sub-LU 25 after main/sub switching from the path management table 122.

The device link manager 127 of the host computer 10 stores information indicating the sub-LU 25 in copy attributes 1226 of all the selected records. The device link manager 127 of the host computer 10 stores information indicating an abnormality in statuses 1229 of all the selected records. The device link manager 127 of the host computer 10 stores information indicating that the write request cannot be transmitted by using the path 17 in write request flags 1231 of all the selected records.

The device link manager 127 of the host computer 10 stores information indicating that the read request cannot be transmitted by using the path 17 in read request flags 1230 of all the selected records.

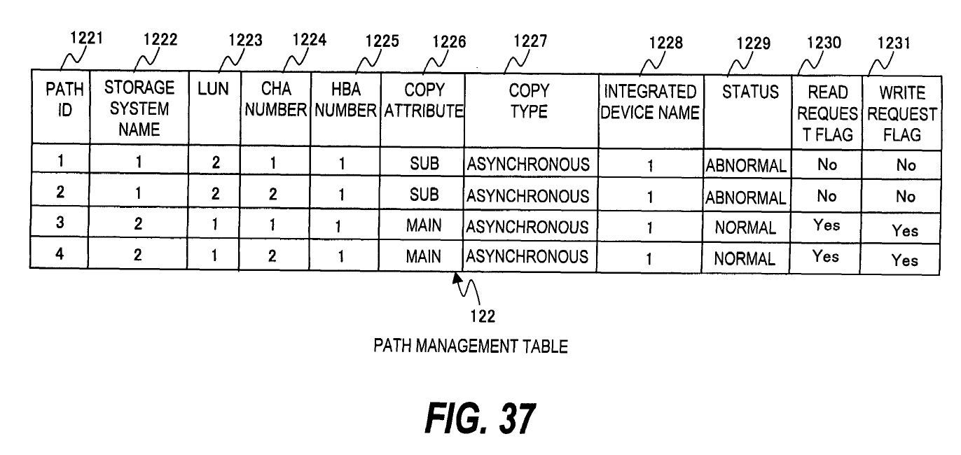

Thus, the device link manager 127 of the host computer 10 updates the path management table 122 (S222). For example, the device link manager 127 of the host computer 10 updates the path management table 122 shown in FIG. 31 to the path management table 122 shown in FIG. 37.

FIG. 37 is a diagram showing a configuration of the path management table 122 stored in the host computer 10 after the path failure occurs according to the first embodiment of this invention.

The path management table 122 shown in FIG. 37 is a case where failures occur in a path 17 identified by “1” of the path ID 1221 and a path 17 identified by “2” of the path ID 1221. In this case, the LU 25 connected to the failed path 17 is changed from the main LU 25 to the sub-LU 25. In addition, the LU 25 making a copy pair with the LU 25 connected to the failed path 17 is changed from the sub-LU 25 to the main LU 25.

Accordingly, the device link manager 127 of the host computer 10 transmits an I/O request issued from the task application 126 to the integrated device 128 to the storage system 20 by using a path 17 identified by “3” of the path ID 1221 and a path 17 identified by “4” of the path ID 1221. In other words, the device link manager 127 of the host computer 10 transmits the I/O request to the storage system 20 by using only the path 17 connected to the main LU 25 after the main/sub switching.

Now, the process returns to FIGS. 35 and 36.

After updating of the path management table 122, the device link manager 127 of the host computer 10 resumes the task application 126 stopped in the step S202 of the process when a failure is detected (FIGS. 32 and 33) (S223).

Then, the device link manager 127 of the host computer 10 finishes the process when the path failure occurs.

FIG. 38 is an explanatory diagram of a process executed by the host computer 10 when an LU failure occurs according to the first embodiment of this invention. FIG. 39 is a flowchart of the process executed by the host computer 10 when the LU failure occurs according to the first embodiment of this invention.

The device link manager 127 of the host computer 10 receives a copy pair release notification 53 (S231).

Then, the device link manager 127 of the host computer 10 selects all records where a storage system name 533 of the received copy pair release notification 53 matches the storage system name 1222 of the path management table 122 from the path management table 122. The device link manager 127 of the host computer 10 selects all records where an LUN 534 of the received copy pair release notification 53 matches the LUN 1223 of the path management table 122 from the selected records. Accordingly, the device link manager 127 of the host computer 10 selects records regarding the main LU 25 before copy pair releasing from the path management table 122. The main LU 25 is a failed LU 25.

The device link manager 127 of the host computer 10 deletes copy attributes 1226 and copy types 1227 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

The device link manager 127 of the host computer 10 selects all records where a storage system name 535 of the received copy pair release notification 53 matches the storage system name 1222 of the path management table 122 from the path management table 122. The device link manager 127 of the host computer 10 selects all records where an LUN 536 of the received copy pair release notification 53 matches the LUN 1223 of the path management table 122 from the selected records. Accordingly, the device link manager 127 of the host computer 10 selects records regarding the sub-LU 25 before copy pair releasing from the path management table 122.

The device link manager 127 of the host computer 10 deletes copy attributes 1226 and copy types 1227 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

Then, the device link manager 127 of the host computer 10 selects all records where a storage system name 537 of the received copy pair release notification 53 matches the storage system name 1222 of the path management table 122 from the path management table 122. The device link manager 127 of the host computer 10 selects all records where an LUN 538 of the received copy pair release notification 53 matches the LUN 1223 of the path management table 122 from the selected records. Accordingly, the device link manager 127 of the host computer 10 selects records regarding the LU 25 excluded from the integrated device 128 from the path management table 122. In this case, the device link manager 127 of the host computer 10 selects records regarding the main LU 25 before copy pair releasing from the path management table 122.

The device link manager 127 of the host computer 10 deletes integrated device names 1228 of all the selected records. The device link manager 127 of the host computer 10 stores information indicating that the read request cannot be transmitted by using the path 17 in read request flags 1230 of all the selected records. The device link manager 127 of the host computer 10 stores information indicating that the write request cannot be transmitted by using the path 17 in write request flags 1231 of all the selected records.

Accordingly, the device link manager 127 of the host computer 10 does not use the path 17 connected to the LU 25 excluded from the integrated device 128 for transmitting the I/O request issued from the task application 126 to the integrated device 128.

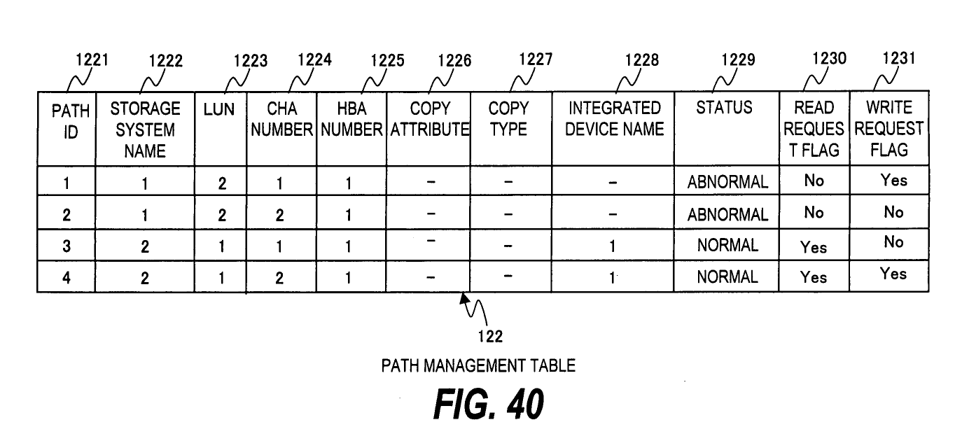

Thus, the device link manager 127 of the host computer 10 updates the path management table 122 (S232). For example, the device link manager 127 of the host computer 10 updates the path management table 122 shown in FIG. 31 to the path management table 122 shown in FIG. 40.

FIG. 40 is a diagram showing a configuration of the path management table 122 stored in the host computer 10 after the LU failure occurs according to the first embodiment of this invention.

The path management table 122 shown in FIG. 40 is a case where a failure occurs in an LU 25 identified by “2” of the LUN 1223 provided by the storage system 20 identified by “1” of the storage system name 1222. In this case, a copy pair which includes the failed LU 25 is released. The failed LU 25 is excluded from the integrated device 128.

Accordingly, the device link manager 127 of the host computer 10 transmits an I/O request issued from the task application 126 to the integrated device 128 to the storage system 20 by using a path 17 identified by “3” of the path ID 1221 and a path 17 identified by “4” of the path ID 1221. In other words, the device link manager 127 of the host computer 10 transmits the I/O request to the storage system 20 by using only the path 17 connected to the LU 25 not excluded from the integrated device 128.

Now, the process returns to FIGS. 38 and 39.

After updating of the path management table 122, the device link manager 127 of the host computer 10 resumes the task application 126 stopped in the step S202 of the process when the failure is detected (FIGS. 32 and 33) (S233).

Then, the device link manager 127 of the host computer 10 finishes the process when the LU failure occurs.

FIG. 41 is an explanatory diagram of a process executed by the host computer 10 when a copy path failure occurs according to the first embodiment of this invention. FIG. 42 is a flowchart of the process executed by the host computer 10 when the copy path failure occurs according to the first embodiment of this invention.

The device link manager 127 of the host computer 10 receives a copy holding request 54 (S241).

Then, the device link manager 127 of the host computer 10 selects all records where a storage system name 543 of the received copy holding request 54 matches the storage system name 1222 of the path management table 122 from the path management table 122. The device link manager 127 of the host computer 10 selects all records where an LUN 544 of the received copy holding request 54 matches the LUN 1223 of the path management table 122 from the selected records. Accordingly, the device link manager 127 of the host computer 10 selects records regarding the main LU 25 before copy pair releasing from the path management table 122.

The device link manager 127 of the host computer 10 deletes copy attributes 1226 and copy types 1227 of all the selected records. The device link manager 127 of the host computer 10 stores information indicating a copy path failure in statuses 1229 of all the selected records.

The device link manager 127 of the host computer 10 selects all records where a storage system name 545 of the received copy holding request 54 matches the storage system name 1222 of the path management table 122 from the path management table 122. The device link manager 127 of the host computer 10 selects all records where an LUN 546 of the received copy holding request 54 matches the LUN 1223 of the path management table 122 from the selected records. Accordingly, the device link manager 127 of the host computer 10 selects records regarding the sub-LU 25 before copy pair releasing from the path management table 122.

The device link manager 127 of the host computer 10 deletes copy attributes 1226 and copy types 1227 of all the selected records. The device link manager 127 of the host computer 10 stores information indicating the copy path failure in statuses 1229 of all the selected records. The device link manager 127 of the host computer 10 stores information indicating that the read request can be transmitted by using the path 17 in read request flags 1230 of all the selected records. The device link manager 127 of the host computer 10 stores information indicating that the write request can be transmitted by using the path 17 in write request flags 1231 of all the selected records.

Accordingly, the device link manager 127 of the host computer 10 transmits the I/O request issued from the task application 126 to the integrated device 128 to all the LU's 25 provided as the integrated devices 128.

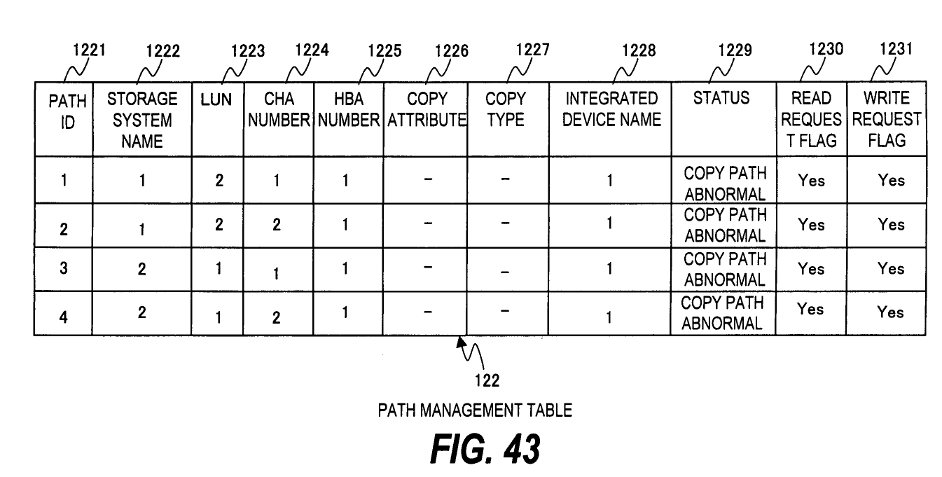

Thus, the device link manager 127 of the host computer 10 updates the path management table 122 (S242). For example, the device link manager 127 of the host computer 10 updates the path management table 122 shown in FIG. 31 to the path management table 122 shown in FIG. 43.

FIG. 43 is a diagram showing a configuration of the path management table 122 stored in the host computer 10 after the LU failure occurs according to the first embodiment of this invention.

The path management table 122 shown in FIG. 43 is a case where a failure occurs in a copy path. The failed copy path interconnects an LU 25 identified by “2” of the LUN 1223 provided by the storage system 20 identified by “1” of the storage system name 1222 and an LU 25 identified by “1” of the LUN 1223 provided by the storage system 20 identified by “2” of the LUN 1223. In this case, a copy pair which includes the two LU's 25 interconnected through the failed copy path is released.

Accordingly, the device link manager 127 of the host computer 10 transmits a write request issued from the task application 126 to the integrated device 128 to all the LU'S 25 provided as the integrated devices 128. In other words, the device link manager 127 of the host computer 10 transmits the I/O request to both of the main LU 25 and the sub-LU 25 before copy pair releasing.

For example, the device link manager 127 of the host computer 10 transmits the I/O request issued to the integrated device name 128 identified by “1” of the integrated device name 1228 to the storage system 20 identified by “1” of the storage system name 1222 by using the path 17 identified by “1” of the path ID 1221 or the path 17 identified by “2” of the path ID 1221. The device link manager 127 of the host computer 10 transmits the I/O request to the storage system 20 identified by “2” of the storage system name 1222 by using the path 17 identified by “3” of the path ID 1221 or the path 17 identified by “4” of the path ID 1221.

Now, the process returns to FIGS. 41 and 42.

After updating of the path management table 122, the device link manager 127 of the host computer 10 resumes the task application 126 stopped in the step S202 of the process when the failure is detected (FIGS. 32 and 33) (S243).

Then, the device link manager 127 of the host computer 10 finishes the process when the copy path failure occurs.

It is apparent from the above description that the computer system of the embodiment can be quickly and automatically restored from failures.

### Second Embodiment

According to the first embodiment, the main LU 25 and the sub-LU 25 make a copy pair. According to a second embodiment, a main LU 25 and a sub-LU 25 make an external connection pair.

A configuration of a computer system of the second embodiment is same as that of the first embodiment (FIG. 1). The same components are denoted by similar reference numerals, and description thereof will be omitted.

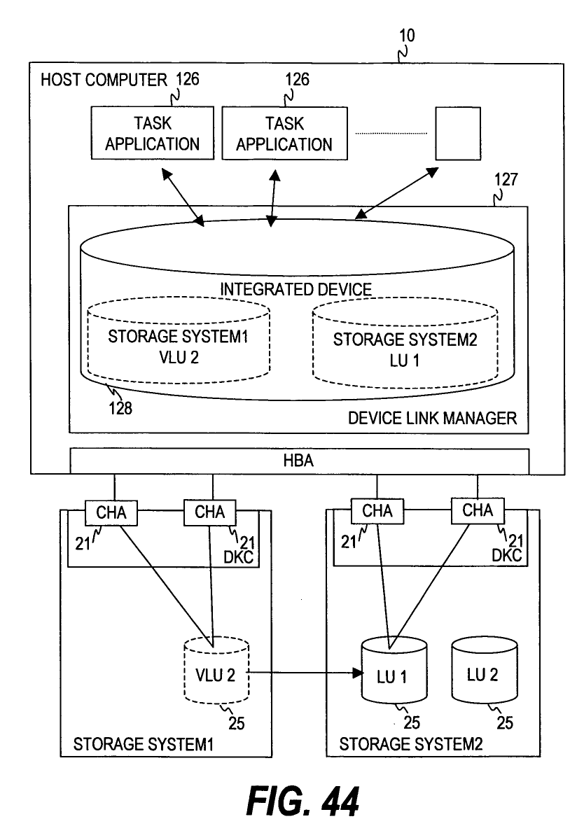

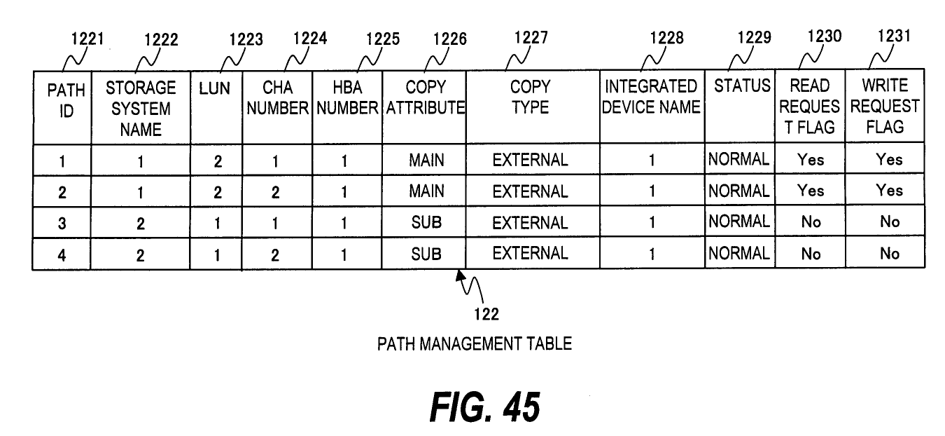

FIG. 44 is an explanatory diagram of an integrated device 128 of the computer system according to the second embodiment of this invention. FIG. 45 is a diagram showing a configuration of a path management table 122 stored in a host computer 10 according to the second embodiment of this invention.

In the explanatory diagram, a storage system 20 identified by “2” of a storage system name 1222 provides an LU 25 identified by “1” of an LUN 1223 to a storage system 20 identified by “1” of a storage system name 1222. The storage system 20 identified by “1” of the storage system name 1222 provides an LU 25 provided by the storage system 20 identified by “2” of the storage system name 1222 as its own LU 25 to the host computer 10. In this case, the storage system 20 identified by “1” of the storage system name 1222 provides the LU 25 provided by the storage system 20 identified by “2” of the storage system name 1222 as an LU 25 identified by “2” of the LUN 1223 to the host computer 10.

Accordingly, the LU 25 provided by the storage system 20 identified by “1” of the storage system name 1222 and identified by “2” of the LUN 1223 is a virtual storage area and actually cannot store data.

Upon reception of an I/O request to the LU 25 identified by “2” of the LUN 1223, the storage system 20 identified by “1” of the storage system name 1222 transfers the received I/O request to the storage system 20 identified by “2” of the storage system name 1222. The storage system 20 identified by “2” of the storage system name 1222 executes the I/O request for the LU 25 identified by “1” of the LUN 1223.

In this case, the LU 25 provided by the storage system 20 identified by “1” of the storage system name 1222 and identified by “2” of the LUN 1223, and the LU 25 provided by the storage system 20 identified by “2” of the storage system 1222 and identified by “1” of the LUN 1223 make an external connection pair.

At a normal time, the LU 25 provided by the storage system 20 identified by “1” of the storage system name 1222 and identified by “2” of the LUN 1223 is treated as a main LU 25. Meanwhile, at a normal time, the LU 25 provided by the storage system name 20 identified by “2” of the storage system name 1222 and identified by “1” of the LUN 1223 is treated as a sub-LU 25.

In other words, at a normal time, the virtual LU 25 included in the two LU's 25 making the external connection pair is treated as a main LU 25. Meanwhile, at a normal time, the LU 25 which actually stores data included in the two LU's 25 making the external connection pair is treated as a sub-LU 25.

The device link manager 127 of the host computer 10 provides the two LU's 25 making the external connection pair as one integrated device 128 to one or more task applications 126. In other words, the device link manager 127 of the host computer 10 provides the main LU 25 and the sub-LU 25 making the external connection pair as one integrated device 128 to one or more task applications 126.

Accordingly, the task application 126 issues an I/O request to the provided integrated device 128. In other words, the task application 126 uses the provided integrated device 128 to access the LU 25 provided by the storage system 20.

In this case, the device link manager 127 of the host computer 10 properly switches a path 17 used for transmitting the I/O request issued from the task application 126. Thus, the device link manager 127 of the host computer 10 realizes a load balance function and a path alternating function without being sensed by the task application 126. In other words, the task application 126 can access the LU 25 through a proper path 17 only by issuing an I/O request to the integrated device 128.

A process of the computer system of the second embodiment is same as that of the first embodiment except for the process described above. Thus, description of the same process will be omitted.

It is apparent from the above description that the computer system can be quickly and automatically restored from failures even when the main LU 25 and the sub-LU 25 make the external connection pair.

While the present invention has been described in detail and pictorially in the accompanying drawings, the present invention is not limited to such detail but covers various obvious modifications and equivalent arrangements, which fall within the purview of the appended claims.

What is claimed is:

1. A path management method for a computer system comprising: a first storage controller; a second storage controller; and a host computer coupled to the first and second storage controllers,
the first storage controller providing a first volume to the host computer,
the second controller providing a second volume making a pair with the first volume to the host computer,
the host computer including: at least one task application unit for issuing a write request and a read request; and a path management unit for managing an access route to each of the volumes,
the path management method comprising:
setting, by the path management unit, a plurality of first paths serving as access routes from the host computer to the first volume, and a plurality of second paths serving as access routes from the host computer to the second volume;
providing, by the path management unit, the first and second volumes as third volume to the task application unit; and
transmitting, by the path management unit, through the first path the write request for writing data in the third volume which is issued from the task application unit.

2. The path management method according to claim 1, wherein:
the pair comprises a copy pair;
the computer system further comprises a first physical disk coupled to the first storage controller, and a second physical disk coupled to the second storage controller; and
the path management method further comprises:
providing, by the second storage controller, a storage area of the second physical disk as the second volume to the host computer;
providing, by the first storage controller, a storage area of the first physical disk as the first volume to the host computer;
receiving, by the first storage controller, the write request transmitted through the first path;
writing, by the first storage controller, data in the first volume according to the received write request; and
copying, by the first storage controller, the data written in the first volume to the second volume.

3. The path management method according to claim 2, further comprising:
transmitting, by the path management unit, through the second path the write request for writing data in the third volume which is issued from the task application unit, upon detection of a failure in at least one of the first volume and the first path;
receiving, by the second storage controller, the write request transmitted through the second path;
writing, by the second storage controller, data in the second volume according to the received write request; and
copying, by the second storage controller, the data written in the second volume to the first volume.

4. The path management method according to claim 1, wherein:
the pair comprises an external connection pair;
the computer system further comprises a second physical disk coupled to the second storage controller; and
the path management method further comprises:
providing, by the second storage controller, a storage area of the second physical disk as the second volume to the host computer and the first storage controller;
providing, by the first storage controller, the second volume provided by the second storage controller as the first volume to the host computer;
receiving, by the first storage controller, the write request transmitted through the first path; and
requesting, by the first storage controller, the second storage controller to write data in the second volume according to the received write request.

5. The path management method according to claim 4, further comprising:
transmitting, by the path management unit, through the second path the write request for writing data in the third volume which is issued from the task application unit, upon detection of a failure in at least one of the first volume and the first path;
receiving, by the second controller, the write request transmitted through the second path; and
writing, by the second controller, data in the second volume according to the received write request.

6. The path management method according to claim 1, further comprising:
transmitting, by the path management unit, through one of the first and second paths the read request for reading data from the third volume which is issued from the task application unit in a case where data of the first volume is synchronized with data of the second volume; and
transmitting, by the path management unit, through the first path the read request for reading data from the third volume which is issued from the task application unit in a case where the data of the first volume is not synchronized with the data of the second volume.

7. The path management method according to claim 1, further comprising transmitting, by the path management unit, through both of the first path and the second path the write request for writing data in the third volume which is issued from the task application unit, upon detection of a failure of a third path serving as an access route from the first volume to the second volume.

8. The path management method according to claim 1, wherein the processing of transmitting the write request comprises the processings of:
selecting, by the path management unit, normal first paths from the plurality of first paths;
selecting, by the path management unit, first path from the selected normal first paths by a round robin system; and
transmitting, by the path management unit, through the selected first path the write request for writing data in the third volume which is issued from the task application unit.

9. A host computer coupled to a first storage controller for providing a first volume, and a second storage controller for providing a second volume making a pair with the first volume, comprising:
at least one task application unit for issuing a write request and a read request; and
a path management unit for managing an access route to each of the volumes,
wherein the path management unit is configured to:
set a plurality of first paths serving as access routes from the host computer to the first volume, and a plurality of second paths serving as access routes from the host computer to the second volume;
provide the first and second volumes as a third volume to the task application unit; and
transmit through the first path the write request for writing data in the third volume which is issued from the task application unit.

10. The host computer according to claim 9, wherein the path management unit is further configured to transmit through the second path the write request for writing data in the third volume which is issued from the task application unit, upon detection of a failure in at least one of the first volume and the first path.

11. The host computer according to claim 9, wherein the path management unit is configured to:
transmit through one of the first and second paths the read request for reading data from the third volume which is issued from the task application unit in a case where data of the first volume is synchronized with data of the second volume; and
transmit through the first path the read request for reading data from the third volume which is issued from the task application unit in a case where the data of the first volume is not synchronized with the data of the second volume.

12. The host computer according to claim 9, wherein the path management unit is further configured to transmit through both of the first path and the second path the write request for writing data in the third volume which is issued from the task application unit, upon detection of a failure of a third path serving as an access route from the first volume to the second volume.

13. The host computer according to claim 9, wherein the path management unit is further configured to:
select normal first paths from the plurality of first paths;
select first path from the selected normal first paths by a round robin system; and
transmit through the selected first path the write request for writing data in the third volume which is issued from the task application unit.

14. A path management program for a host computer coupled to a first storage controller for providing a first volume, and a second storage controller for providing a second volume, the host computer executing a task application, the path management program controlling the host computer to execute the processings of:
setting a plurality of first paths serving as access routes from the host computer to the first volume, and a plurality of second paths serving as access routes from the host computer to the second volume;
providing the first and second volumes as a third volume to the task application unit; and
transmitting through the first path the write request for writing data in the third volume which is issued from the task application.

15. The path management program according to claim 14, further controlling the host computer to execute the processings of transmitting through the second path the write request for writing data in the third volume which is issued from the task application upon detection of a failure in at least one of the first volume and the first path.

16. The path management program according to claim 14, further controlling the host computer to execute the processings of:
transmitting through one of the first and second paths the read request for reading data from the third volume which is issued from the task application in a case where data of the first volume is synchronized with data of the second volume; and
transmitting through the first path the read request for reading data from the third volume which is issued from the task application in a case where the data of the first volume is not synchronized with the data of the second volume.

17. The path management program according to claim 14, further controlling the host computer to execute the processings of transmitting through both of the first path and the second path the write request for writing data in the third volume which is issued from the task application upon detection of a failure of a third path serving as an access route from the first volume to the second volume.

18. The path management program according to claim 14, wherein the processing of transmitting the write request comprises the processings of:
selecting normal first paths from the plurality of first paths;
selecting first path from the selected normal first paths by a round robin system; and
transmitting through the selected first path the write request for writing data in the third volume which is issued from the task application.
